(19) United States
(12) Patent Application Publication
(10) Pub. No.: US 2025/0392077 A1
(43) Pub. Date: Dec. 25, 2025

(54) Type-C Receptacle Load-Bearing Docking Protection Device

(71) Applicant: Shenzhen Merrtek Technology Co., Ltd., Shenzhen (CN)

(72) Inventors: Gaodi ZOU, Shenzhen (CN); Rongshen PENG, Shenzhen (CN)

(21) Appl. No.: 18/037,767

(22) PCT Filed: Mar. 31, 2023
(86) PCT No.: PCT/CN2023/085738

§ 371 Date: May 18, 2023

(30) Foreign Application Priority Data
Jan. 13, 2023 (CN) 2023100833279
Mar. 31, 2023 (WO) PCT/CN2023/085738

(51) Int. Cl. H01R 13/639; H01R 13/629

(52) U.S. Cl. CPC H01R 13/639; H01R 13/629

(57) ABSTRACT

The present invention provides a Type-C receptacle load-bearing docking protection device and application thereof, wherein the Type-C receptacle load-bearing docking protection device solves the drawback of poor docking stability of the Type-C receptacle under load-bearing condition while using the Type-C receptacle as the standard receptacle for cable docking, so as to adapt for load-bearing cable docking of a load-bearing docking type motion sensor in form of microwave sensors/pyroelectric infrared sensor/ultrasonic sensor with Type-C receptacle and a relative apparatus (such as lamps, power supplies, power supply sockets), and for implementing rapid plugging installation of the load-bearing docking type motion sensor and the relative apparatus when being applied to load-bearing cable docking of the load-bearing docking type motion sensor with Type-C receptacle and the relative apparatus, which has the convenient advantage of plug-and-play, and can ensure a docking stability between the load-bearing docking type motion sensor with Type-C receptacle and the relative apparatus.

### CROSS REFERENCE OF RELATED APPLICATION

This is a non-provisional application U.S. National Stage under 35 U.S.C. 371 of the International Application Number PCT/CN2023/085738, filed Mar. 31, 2023, which claims priority to Chinese application number CN2023100833279, filed Jan. 13, 2023, which are incorporated herewith by references in their entireties.

### BACKGROUND OF THE PRESENT INVENTION

### Field of Invention

The present invention relates to the field of load-bearing cable docking, and particularly to a Type-C receptacle load-bearing docking protection device and application thereof.

### Description of Related Arts

USB is the abbreviation of Universal Serial Bus which is a standard of external bus for regulating the connection and communication between computer device and peripheral devices and is a docking and interface technology applied in the field of PC, personal computer. Since USB-IF (USB Implementers Forum) organization released the USB 1.0 standard, the USB standard developed various versions, including USB 1.1, USB 2.0, USB 3.0, USB 3.1, USB 3.2, and USB 4.0. USB receptacle is classified into Type-A receptacle, Type-B receptacle, Mini USB receptacle, Micro USB receptacle, Type-C receptacle, and etc., wherein the Type-A receptacle is one of the most common USB receptacles and widely applied in devices such as mouses, keyboards, flash memories, and etc. Type-B receptacle is generally equipped in apparatus such as printers, scanners, specific monitors, and etc. Mini USB receptacle has a relatively smaller size and is commonly used in some small devices, such as MP3, MP4, radio, etc., as well as certain old model mobile phones. In the early stage of the development of smart phones, most smart phones (except the iPhone of Apple) equipped Micro-B receptacle as for charging port and data docking. The enclosures of USB 3.0 portable hard disk and flash memory generally use the Micro-B receptacle. Type-C receptacle is an innovative type of USB receptacle being applied recently, wherein the Type-C has a much smaller size than the Type-A and the Type-B and the latest standard symmetrical form for USB receptacle, without the differences between positive and negative orientations, for plugging and connecting in either orientation. Most of the new smartphones equip the charging port with Type-C receptacle currently while the Type-C receptacle has also become the standard receptacle for notebook computer chargers.

More particular, according to the structure and standard of the Type-C receptacle, a perception to the public of the Type-C receptacle is that it is only suitable for use in the electronic devices that require fast charging and high-speed data transmission, such as smart phones, computers, PCs, tablet computers, headsets, digital cameras, portable navigation systems, and even display devices, while its applications are also limited to such products. In the current art, the Type-C receptacle has not been applied to the field of load-bearing cable docking and connecting between motion sensors (such as microwave sensors and pyroelectric infrared sensors) and relative apparatuses (such as lamps and power supplies). It is because the Type-C receptacle is small in size, so that when these motion sensors are connected to related apparatuses, the load-bearing docking structure between the corresponding plug connector and the receptacle connector is likely to be partially or entirely obscured. Unlike the Type-C receptacle applied to electronic devices such as smart phones, the Type-C plug and Type-C receptacle are directly observable with human eyes to ensure the Type-C plug being inserted into the Type-C receptacle precisely and smoothly. In other words, while the Type-C receptacle is applied to the connection between the motion sensor and its relative apparatus, the small size of the Type-C receptacle is no longer an advantage. It becomes a challenge for how to precisely insert the Type-C plug into the corresponding Type-C receptacle while they are obscured. On the other hand, the Type-C receptacle is often applied in a temporary connection scenario. For example, when it is applied to a mobile phone, the connection of Type-C plug and the Type-C receptacle is for temporary charging or data transmission since there is no load-bearing docking issue between the charging plug and the mobile phone. However, the connection between the motion sensor and relative apparatuses has certain load-bearing requirements. That is, it not only needs to ensure the electrical connection relationship between the motion sensor and relative apparatus, but also involves how to resolve the problem of load-bearing installation between motion sensor and the relative apparatus through the connection structure between the connector plug and the connector receptacle thereof.

In addition, practically, the installation and fixation between the motion sensor and relative apparatus often adopts threaded connecting method or rotational buckling method. If the Type-C is used for cable docking and connection with such installation and fixation method, it is easy to cause damage to the Type-C receptacle or affect the stability of the electrical connection of the Type-C receptacle. Therefore, the industry is more likely to design and use other docking and connection methods for the load-bearing cable docking between the motion sensor and the relative apparatuses. For example, using mutual matching helical docking connection for the contact type wiring between the electric probe and the conductive ring/disc. However, such contact type wiring often has the problem of poor contact, and that the friction between the electric probe and the conductive ring/disk is large during the screwing process causes damage to the electric probe and the conductive ring/disk easily, that further aggravates the problem of poor contact. In addition, such non-standard docking has poor universality, which is not beneficial to the standardization of the connection between the motion sensor and relative apparatuses, and that the transmission of control signals merely through one conductive probe of the electric probes fails to meet the networking requirements of the Internet of Things.

### SUMMARY OF THE PRESENT INVENTION

An objective of the present invention is to provide a Type-C receptacle load-bearing docking protection device and application thereof, wherein the Type-C receptacle load-bearing docking protection device equips a Type-C receptacle as a standard receptacle for cable docking and connection, that is not only adapted for standardization, but also has wide range applicability while providing support features to the high-power supply docking and high-speed data docking for the Type-C receptacle.

Another objective of the present invention is to provide a Type-C receptacle load-bearing docking protection device and application thereof, wherein the Type-C receptacle load-bearing docking protection device solves the shortcoming of poor docking stability of the Type-C receptacle under load-bearing conditions while using the Type-C receptacle as the standard receptacle for cable docking. Accordingly, it is adapted for application requirements based on human body/object (such as vehicle) motion detection for load-bearing cable docking connection between the load-bearing docking type motion sensor like microwave sensor/pyroelectric infrared sensor/ultrasonic sensor with the Type-C receptacle and the relative apparatuses (such as lamps, power supplies, and power sockets). In addition, when it is applied to the load-bearing cable docking connection between the load-bearing docking type motion sensor with Type-C receptacle with the relative apparatuses, the docking stability between the load-bearing cable docking type motion sensor with the Type-C receptacle and respective apparatus is ensured.

Another objective of the present invention is to provide a Type-C receptacle load-bearing docking protection device and application thereof, wherein the Type-C receptacle load-bearing docking protection device, which equips a Type-C receptacle as the standard receptacle for cable docking, is able to ensure the docking and connecting precision of the Type-C receptacle while the Type-C receptacle is obscured in the insertion direction by the corresponding load-bearing structure, so as to be capable of applying to the load-bearing cable docking and connection between the load-bearing docking motion sensor with the Type-C receptacle and the relative apparatus and providing quick plugging installation of the load-bearing docking motion sensor with Type-C receptacle and the relative apparatus, as well as a convenient advantage of plug and play.

Another objective of the present invention is to provide a Type-C receptacle load-bearing docking protection device and application thereof, wherein while the Type-C receptacle load-bearing docking protection device equips the Type-C receptacle as the standard receptacle for cable docking, the advantage of being plugged out easily of the Type-C receptacle is ensured under load-bearing docking condition. Accordingly, while it is appliable to the load-bearing cable docking connection between the load-bearing docking type motion sensor with Type-C receptacle and the relative apparatus, the rapid unplugging of the load-bearing docking type motion sensor and the relative apparatus is ensured.

Another objective of the present invention is to provide a Type-C receptacle load-bearing docking protection device and application thereof, wherein the Type-C receptacle load-bearing docking protection device equips the Type-C receptacle as the standard receptacle for cable docking, while solving the shortcomings of the poor docking stability of the Type-C receptacle under load-bearing conditions and having the multiple plugging advantage of the Type-C receptacle, so that while it is applicable to the load-bearing cable docking connection between the load-bearing docking type motion sensor with Type-C receptacle and the relative apparatus, it allows repeatedly plugging and unplugging of the load-bearing docking type motion sensor with Type-C receptacle and the relative apparatus.

Another objective of the present invention is to provide a Type-C receptacle load-bearing docking protection device and a load-bearing docking type motion sensor with Type-C receptacle, wherein the load-bearing docking type motion sensor with Type-C receptacle is arranged in form of microwave sensor/pyroelectric infrared sensor/ultrasonic sensor, while the Type-C receptacle is used as the standard receptacle of cable docking connection of the Type-C load-bearing docking protection device, wherein the Type-C receptacle load-bearing docking protection device includes a first receptacle mounting base, a second receptacle mounting base, a first Type-C receptacle, a second Type-C receptacle, a first load-bearing docking housing, and a second load-bearing docking housing, wherein the first Type-C receptacle and the second Type-C receptacle are paired and matched as male receptacle and female receptacle respectively, wherein the first Type-C receptacle is fixedly mounted on the first receptacle mounting base, and the second Type-C receptacle is fixedly mounted on the second receptacle mounting base, wherein the first receptacle mounting base is installed in the first load-bearing docking housing and the second receptacle mounting base is installed in the second load-bearing docking housing. At least one of the first receptable mounting base and the second receptable mounting base is arranged in a repositionable and movable manner with respect to the corresponding first or second load-bearing docking housing, so as to ensure a movable docking action between the first load-bearing docking housing and the second load-bearing docking housing during a mutually plugging condition between the first Type-C receptacle and the second Type-C receptacle. Accordingly, during the movable docking action between the first load-bearing docking housing and the second load-bearing docking housing is performed, the docking stability of the second Type-C receptacle with respect to the first Type-C receptacle is ensured. Also, while the respective load-bearing docking housing is used as a housing of the load-bearing docking type motion sensor with Type-C receptacle correspondingly, the plugging and connecting stability of the load-bearing docking type motion sensor with Type-C receptacle and the relative apparatus is guaranteed.

Another objective of the present invention is to provide a Type-C receptacle load-bearing docking protection device and a load-bearing docking type motion sensor with Type-C receptacle, wherein at least one of the first receptacle mounting base and the second receptacle mounting base is arranged in a repositionable and movable manner with respect to the corresponding first or second load-bearing docking housing, so that when a movement between the first load-bearing docking housing and the second load-bearing docking housing releases the mutual docking condition between the first load-bearing docking housing and the second load-bearing docking housing, a displacement occurred during the movable docking action between the first load-bearing docking housing and the second load-bearing docking housing with respect to the arrangement of the corresponding load-bearing docking housing in the repositionable and movable manner between the respective receptacle mounting base and the respective load-bearing docking housing is able to be repositioned and be retained in the reposition condition. Correspondingly, the active docking structure between the first load-bearing docking housing and the second load-bearing docking housing is able to maintain independence with respect to the mutual plugging and connecting structure between the first load-bearing docking housing and the second load-bearing docking housing, and thus during the repeatedly plugging and connecting process between the first load-bearing docking housing and the second load-bearing docking housing, the docking precision of the first Type-C receptacle and the second Type-C receptacle is ensured, so that when the Type-C receptacle load-bearing docking protection device is able to be applied to load-bearing cable docking between the load-bearing docking type motion sensor with Type-C receptacle and the relative apparatus, the repeatedly plugging and unplugging between the load-bearing docking type motion sensor with Type-C receptacle and the relative apparatus can easily be implemented.

Another object of the present invention is to provide a Type-C receptacle load-bearing docking protection device and a load-bearing docking type motion sensor with a Type-C receptacle, wherein the first Type-C receptacle is fixedly installed in the first receptacle mounting base by being embedded in the first receptable mounting base, wherein an opening of the first Type-C receptacle is oriented in a height direction of the first receptacle mounting base. The first receptacle mounting base has a plug-in limiting surface raised in the height direction thereof and at least one movement limiting groove positioned at a side position of the first Type-C receptacle and extended in a plugging direction of the first Type-C receptacle. The second Type-C receptacle is fixedly mounted on the second receptable mounting base, wherein an opening of the second Type-C receptacle is oriented in a height direction of the second receptable mounting base. The second receptable mounting base has at least one movement limiting member positioned at a side position of the second Type-C receptacle and extended in the height direction thereof, wherein the at least one movement limiting member is sized and shaped structurally matching with the at least one movement limiting groove and is preferably higher than an opening of the Type-C receptacle, wherein when the first Type-C receptacle is aligned with the second Type-C receptacle along the plugging direction of the first Type-C receptacle and the second Type-C receptacle, the opening of the at least one movement limiting groove, located on the plug-in limiting surface is maintained being aligned with the movement limiting member. Accordingly, during the engaging of the first docking ring and the second docking ring, by means of the insertion and positioning of the movement limiting member and the movement limiting groove, the alignment and positioning of the first Type-C receptacle and the second Type-C receptacle are further ensured, and that by means of the butting between the first Type-C receptacle and the second Type-C receptacle and/or the abutment between the plug-in limiting surface and the and the second receptacle mounting base along the plugging direction of the first Type-C receptacle and the second Type-C receptacle, a protection to limit a plugging depth of the first Type-C receptacle and the second Type-C receptacle is implemented. In addition, by means of the docking of the at least one movement limiting member and the at least one movement limiting groove provided at lateral sides of the first Type-C receptacle and the second Type-C receptacle, the relative lateral movement of the first Type-C receptacle 30 and the second Type-C receptacle is limited and protected. Furthermore, during the engaging of the first docking ring and the second docking ring, the docking precision and stability of the first Type-C receptacle and the second Type-C receptacle are further guaranteed.

Another object of the present invention is to provide a Type-C receptacle load-bearing docking protection device and a load-bearing docking type motion sensor with a Type-C receptacle, wherein the first receptacle mounting base is installed to the first load-bearing docking housing, and the second receptacle mounting base is installed to the second load-bearing docking housing. At least one receptacle mounting base of the first receptable mounting base and the second receptable mounting base is arranged in a repositionable and movable manner with respect to the corresponding load-bearing docking housing, so as to ensure the movable docking structure between the first load-bearing docking housing and the second load-bearing docking housing with respect to mutual docking structure between the first receptable mounting base and the second receptacle mounting base maintains independence, so as to adapt different structural design requirements and reduce the interdependence of the movable docking structure between the first load-bearing docking housing and the second load-bearing docking housing and the docking structure between the first receptable mounting base and the second receptable mounting base, and thus reducing the matching accuracy requirements of the movable docking structure between the first load-bearing docking housing and the second load-bearing docking housing and the docking structure between the first receptacle mounting base and the second receptacle mounting base.

According to one aspect of the present invention, the present invention provides a Type-C receptacle load-bearing docking protection device, which includes:
a first receptacle mounting base;
a second receptacle mounting base;
a first Type-C receptacle and a second Type-C receptacle which are configured to match each other in form of a Type-C male receptacle and a Type-C female receptacle respectively, wherein the first Type-C receptacle is fixedly installed to the first receptable mounting base and the second Type-C receptacle is fixedly installed to the second receptable mounting base;
a first load-bearing docking housing and a second load-bearing docking housing, wherein the first load-bearing docking housing and the second load-bearing docking housing are arranged to match to each other to be adapted for docking with each other so as to be able to bear loading in an unplugging direction of the first Type-C receptacle and the second Type-C receptacle, wherein the first receptable mounting base is installed to the first load-bearing docking housing and the second receptable mounting base is installed to the second load-bearing docking housing, wherein at least one receptacle mounting base of the first receptacle mounting base and the second receptacle mounting base is arranged in a repositionable and movable manner with respect to one load-bearing ducking housing of the first load-bearing docking housing and the second load-bearing docking housing correspondingly, so that a movable docking action between the first load-bearing docking housing and the second load-bearing docking housing is able to be implemented in a state while the first Type-C receptacle and the second Type-C receptacle are interplugging together, when a movement between the first load-bearing docking housing and the second load-bearing docking housing releases a mutual docking condition between the first load-bearing docking housing and the second load-bearing docking housing, a displacement occurred between the one receptacle mounting base arranged in the repositionable and movable manner and the one load-bearing docking housing during the movable docking action of the first load-bearing docking housing and the second load-bearing docking housing is able to be restored and repositioned and be retained in a repositioned condition.

In one embodiment, at least one of the first receptacle mounting base and the second receptacle mounting base is arranged in a repositionable and rotatable manner with respect to the corresponding first or second load-bearing docking housing.

In one embodiment, the first load-bearing docking housing has at least one guiding groove extending in a plugging direction of the first Type-C receptacle and a docking groove extending from a bottom of in a lateral direction of the guiding groove integrally, wherein the second load-bearing docking housing has at least one guide docking protrusion provided in a plugging direction of the second Type-C receptacle and the first Type-C receptacle, such that when the guide docking protrusion is aligned with a groove opening of the guiding groove, an alignment of the first Type-C receptacle and the second Type-C receptacle is maintained in a direction of a mutual plugging and connection thereof, and that corresponding to a plugging process of the first Type-C receptacle and the second Type-C receptacle, the guide docking protrusion slides along the guiding groove, wherein based on a rotation movement of the first load-bearing docking housing with respect to the second load-bearing docking housing, the guide docking protrusion of the second load-bearing docking housing slides along the docking groove to implement a rotating docking of the first load-bearing docking housing and the second load-bearing docking housing.

In one embodiment, a shape of an opening of each of the first and second Type-C receptacles satisfies a vertical symmetry line and a horizontal symmetry line that are perpendicular to each other. There are two guide docking protrusions which are arranged symmetrically with the vertical symmetry line and the horizontal symmetry line on the second load-bearing docking housing.

In one embodiment, the first load-bearing docking housing includes a first docking ring which defines a first docking chamber. The second load-bearing docking housing includes a second docking ring which defines a second docking chamber, wherein the first Type-C receptacle is fixedly installed in the first receptable mounting base while surrounding by the first docking ring, and the second Type-C receptacle is fixedly installed in the second receptable mounting base while surrounding by the second docking ring, wherein the guiding grooves and the docking groove formed in an inner wall of the first docking ring are provided in the first docking chamber and the guide docking protrusions protruded and extended on an outer wall of the second docking ring are provided in the second docking chamber.

In one embodiment, at least one of the first receptacle mounting base and the second receptable mounting base is installed to the corresponding load-bearing docking housing in a limiting rotatable manner and links with a rotating linkage plate, which is linked and driven by the rotation of the receptacle mounting base with respect to the load-bearing docking housing, wherein the rotating linkage plate is stretchedly linked with a resilient element arranged in the load-bearing docking housing, so as to retain the receptacle mounting base at a stretched and restricted initial state while the receptacle mounting base is limitable and rotatably installed to the load-bearing docking housing, such that the installation of the receptacle mounting base to the load-bearing docking housing in a repositionable and rotatable manner is implemented.

In one embodiment, the receptable mounting base further includes a bottom plate, a linkage member and at least one engaging member, wherein the rotating linkage plate has a linkage slot and at least one engaging slot, wherein the rotating linkage plate is mounted in the receptacle mounting base in such a manner that the linkage member is inserted in the linkage slot and engaged with the rotating linkage plate in a direction of inserting into the linkage groove, and the engaging member is inserted into the linkage groove and engaged with the rotating linkage plate in a pullout direction from the engaging groove.

In one embodiment, the bottom plate has a rotation limiting member, wherein the rotation limiting member is protruded from an edge of the bottom plate, wherein the load-bearing docking housing has an installation channel, a rotation limiting portion in form of recess is defined at a channel opening communicating the installation channel, wherein while the receptacle mounting base is installed to the load-bearing docking housing, the rotation limiting member of the bottom plate is positioned at the rotation limiting portion so as to limit a rotation direction of the receptacle mounting base within a rotating stroke by the rotation limiting portion.

In one embodiment, at least one of the first receptacle mounting base and the second receptacle mounting base is arranged in a repositionable and slidable manner with respect to the corresponding load-bearing docking housing.

In one embodiment, at least one of the first receptacle mounting base and the second receptacle mounting base is arranged in a repositionable and movable manner with respect to the corresponding load-bearing docking housing in a plugging direction of the first Type-C receptacle and second Type-C receptacle.

In one embodiment, an opening of the first Type-C receptacle is oriented in a height direction of the first receptacle mounting base. The first receptacle mounting base has a plug-in limiting surface raised in the height direction thereof and at least one movement limiting groove positioned at a side position of the first Type-C receptacle and extended in a plugging direction of the first Type-C receptacle. An opening of the second Type-C receptacle is oriented in a height direction of the second receptable mounting base. The second receptable mounting base has at least one movement limiting member positioned at a side position of the second Type-C receptacle and extended in the plugging direction in the height direction thereof, wherein the movement limiting member is sized and shaped structurally matching with the movement limiting groove, wherein when the first Type-C receptacle is aligned with the second Type-C receptacle along the plugging direction of the first Type-C receptacle and the second Type-C receptacle, the opening of the movement limiting groove, located on the plug-in limiting surface is maintained being aligned with the movement limiting member.

In one embodiment, the plug-in limiting surface has a height higher than an opening of the Type-C receptacle.

In one embodiment, the shape of the opening of the Type-C receptacle satisfies a vertical symmetry line and a horizontal symmetry line that are perpendicular to each other. There are two movement limiting members and there are two movement limiting grooves correspondingly, wherein the two movement limiting members are arranged symmetrically with the vertical symmetry line and the horizontal symmetry line on two sides of the Type-C receptacle respectively.

According to another aspect of the present invention, the present invention also provides a load-bearing docking type motion sensor with Type-C receptacle, including:
a Type-C receptacle, which is configured as one of a Type-C male receptacle and a Type-C female receptacle;
a receptacle mounting base, wherein the Type-C receptacle is installed to the receptacle mounting base; and
a load-bearing docking housing, wherein the load-bearing docking housing is configured to be docked with a relative apparatus so as to be able to bear loading in an unplugging direction of the Type-C receptacle, wherein the receptacle mounting base is installed to the load-bearing docking housing in a repositionable and moveable manner, such that a docking action between the receptacle mounting base and the relative apparatus is able to be implemented while the Type-C receptacle is in a plugged state, and after a docking condition between the load-bearing docking housing and the relative apparatus is released by a release action between the load-bearing docking housing and the relative apparatus, a displacement occurred between the receptacle mounting base and the load-bearing docking housing during a movable docking action of the load-bearing docking housing and the relative apparatus is able to be restored and repositioned and be retained in a repositioned condition.

In one embodiment, the receptacle mounting base is arranged on the load-bearing docking housing in a repositionable and rotatable manner.

In one embodiment, the receptacle mounting base is installed to the load-bearing docking housing in a limiting rotatable manner and links with a rotating linkage plate, which is linked and driven by the rotation of the receptacle mounting base with respect to the load-bearing docking housing, wherein the rotating linkage plate is stretchedly linked with a resilient element arranged in the load-bearing docking housing, so as to retain the receptacle mounting base at a stretched and restricted initial state while the receptacle mounting base is limitable and rotatably installed to the load-bearing docking housing, such that the installation of the receptacle mounting base to the load-bearing docking housing in a repositionable and rotatable manner is implemented.

In one embodiment, the receptable mounting base further includes a bottom plate, a linkage member and at least one engaging member, wherein the rotating linkage plate has a linkage slot and at least one engaging slot, wherein the rotating linkage plate is mounted in the receptacle mounting base in such a manner that the linkage member is inserted in the linkage slot and engaged with the rotating linkage plate in a direction of inserting into the linkage groove, and the engaging member is inserted into the linkage groove and engaged with the rotating linkage plate in a pullout direction from the engaging groove.

In one embodiment, the bottom plate has a rotation limiting member, wherein the rotation limiting member is protruded from an edge of the bottom plate, wherein the load-bearing docking housing has an installation channel, a rotation limiting portion in form of recess is defined at a channel opening communicating the installation channel, wherein while the receptacle mounting base is installed to the load-bearing docking housing, the rotation limiting member of the bottom plate is positioned at the rotation limiting portion so as to limit a rotation direction of the receptacle mounting base within a rotating stroke by the rotation limiting portion.

In one embodiment, the load-bearing docking housing includes a docking ring which defines a docking chamber, wherein the Type-C receptacle is fixedly installed in the receptable mounting base while surrounding by the docking ring, wherein the load-bearing docking type motion sensor with Type-C receptacle further has an input unit installation position, so as to provide an installation position for the corresponding input unit, wherein the input unit installation position is arranged at the receptacle mounting base or the load-bearing docking housing within the docking chamber.

In one embodiment, the receptacle mounting base is arranged on the load-bearing docking housing in a repositionable and slidable manner.

In one embodiment, the receptacle mounting base is arranged on the load-bearing docking housing in a repositionable and movable manner.

In one embodiment, the Type-C receptacle is affixed to the receptacle mounting base by being embedded in the receptacle mounting base, wherein an opening of the Type-C receptacle is oriented in a height direction of the receptacle mounting base. The first receptacle mounting base has a plug-in limiting surface raised in the height direction thereof and two movement limiting grooves positioned at two side positions of the Type-C receptacle respectively and extended in a plugging direction of the Type-C receptacle, wherein a height of the plug-in limiting surface is higher than the opening of the Type-C receptacle, wherein the two movement limiting grooves are arranged symmetrically at two sides of the Type-C receptacle respectively.

In one embodiment, an opening of the second Type-C receptacle is oriented in a height direction of the second receptable mounting base. The receptable mounting base has two movement limiting members positioned at sides of the Type-C receptacle and extended in the height direction thereof respectively, wherein the two movement limiting members are higher than the opening of the Type-C receptacle, wherein the two movement limiting members are symmetrically arranged at two sides of the Type-C receptacle.

Through the interpretation of the following description and accompanying drawings, further objects and advantages of the present invention will be fully illustrated.

### BRIEF DESCRIPTION OF THE DRAWINGS

FIG. 1A is a partial structural schematic view of a Type-C receptacle load-bearing docking protection device according to one embodiment of the present invention.

FIG. 1B is a partial structural schematic view of the Type-C receptacle load-bearing docking protection device according to the above embodiment of the present invention.

FIG. 2 is a partial structural schematic view of the Type-C receptacle load-bearing docking protection device according to the above embodiment of the present invention.

FIG. 3 is a partial structural schematic view of a Type-C receptacle load-bearing docking protection device according to one embodiment of the present invention.

FIG. 4A is a partial structural schematic view of the Type-C receptacle load-bearing docking protection device according to the above embodiment of the present invention.

FIG. 4B is a partial structural schematic view of the Type-C receptacle load-bearing docking protection device according to the above embodiment of the present invention.

FIG. 4C is a partial structural schematic view of the Type-C receptacle load-bearing docking protection device according to the above embodiment of the present invention.

FIG. 5A is a partial structural schematic view of the Type-C receptacle load-bearing docking protection device according to the above embodiment of the present invention.

FIG. 5B is a partial structural schematic view of the Type-C receptacle load-bearing docking protection device according to the above embodiment of the present invention.

FIG. 5C is a partial structural schematic view of the Type-C receptacle load-bearing docking protection device according to the above embodiment of the present invention.

FIG. 6A is a partial structural schematic view of a Type-C receptacle load-bearing docking protection device according to another embodiment of the present invention.

FIG. 6B is a partial structural schematic view of the Type-C receptacle load-bearing docking protection device according to the above embodiment of the present invention.

FIG. 6C is a partial structural schematic view of the Type-C receptacle load-bearing docking protection device according to the above embodiment of the present invention.

FIG. 7A is a partial structural schematic view of a Type-C receptacle load-bearing docking protection device according to another embodiment of the present invention.

FIG. 7B is a partial structural schematic view of the Type-C receptacle load-bearing docking protection device according to the above embodiment of the present invention.

FIG. 7C is a partial structural schematic view of the Type-C receptacle load-bearing docking protection device according to the above embodiment of the present invention.

FIG. 8A is a partial structural schematic view of a Type-C receptacle load-bearing docking protection device according to another embodiment of the present invention.

FIG. 8B is a partial structural schematic view of a Type-C receptacle load-bearing docking protection device according to another embodiment of the present invention.

FIG. 8C is a partial structural schematic view of a Type-C receptacle load-bearing docking protection device according to another embodiment of the present invention.

FIG. 9A is a perspective view illustrating an application of the Type-C receptacle load-bearing docking protection device to a load-bearing cable docking between a microwave sensor and a lamp according to the above embodiment of the present invention.

FIG. 9B is a cross-sectional view illustrating the application of the Type-C receptacle load-bearing docking protection device applied to the load-bearing cable docking between the microwave sensor and the lamp according to the above embodiment of the present invention.

FIG. 9C is a cross-sectional exploded view illustrating another application of the Type-C receptacle load-bearing docking protection device to the load-bearing line docking of a microwave sensor and a lamp according to the above embodiment of the present invention.

FIG. 10A is a schematic view of an application of the Type-C receptacle load-bearing docking protection device according to one embodiment of the present invention.

FIG. 10B is a schematic view of an application of the Type-C receptacle load-bearing docking protection device according to one embodiment of the present invention.

FIG. 11A is a schematic diagram of an application of the Type-C receptacle load-bearing docking protection device according to one embodiment of the present invention.

FIG. 11B is a schematic diagram of an application of the Type-C receptacle load-bearing docking protection device according to one embodiment of the present invention.

FIG. 12 is a schematic diagram of an application of the Type-C receptacle load-bearing docking protection device according to one embodiment of the present invention.

### DETAILED DESCRIPTION OF THE PREFERRED EMBODIMENT

The following description discloses the present invention to enable those skilled in the art to implement the present invention. The preferred embodiment described in the following description is for example only, and other alternative variations are apparent to those skilled in the art. The basic principles of the present invention defined in the following description can be applied to other embodiments, variations, improvements, equivalents, and other technical solutions without departing from the spirit and scope of the present invention.

Those skilled in the art should understand that, in the disclosure of the present invention, the terms “vertical”, “transverse”, “upper”, “lower”, “front”, “rear”, “left”, “right”, “vertical”, “horizontal”, “top”, “bottom”, “inner”, “outer”, and etc. indicating the orientation or positional relationship are based on the orientation or positional relationship as shown in the drawings, which are only for convenient to describe the present invention and simplify the description, rather than indicating or implying that the device or element referred to must have a specific orientation, rather than to be constructed and operated in a specific orientation, so the above terms should not be construed as limiting the present invention.

It can be understood that the term “a” should be understood as “at least one” or “one or more”, that is, in one embodiment, the number of an element can be one, while in another embodiment, the quantity of the element may be more than one, and the term “a” cannot be understood as a limitation on the quantity.

The present invention provides a Type-C receptacle load-bearing docking protection device and application thereof, wherein the Type-C receptacle load-bearing docking protection device solves the problem of Type-C receptacle while using the Type-C receptacle as the standard receptacle for cable docking, so that it is adapted for load-bearing cable docking between the load-bearing docking type motion sensor with Type-C receptacle, in form of microwave sensors/pyroelectric infrared sensors/ultrasound sensor product according to application requirements of motion detection of human body/object (such as vehicle), and the relative apparatus, so as to ensure the docking and connecting stability between the load-bearing docking type motion sensor with Type-C receptacle and the relative apparatus.

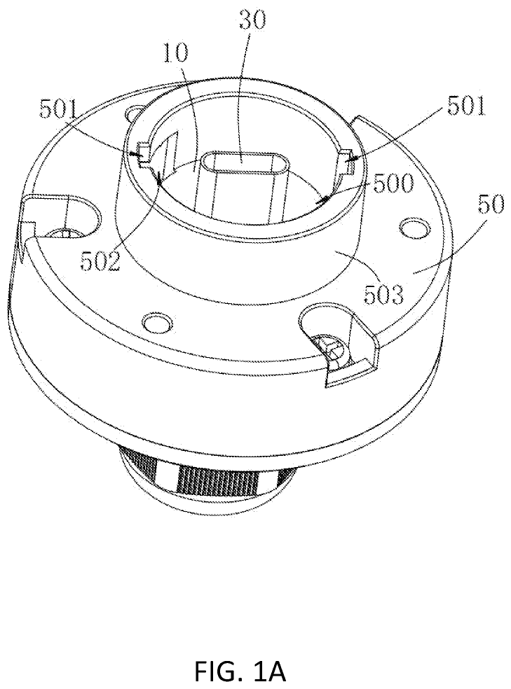

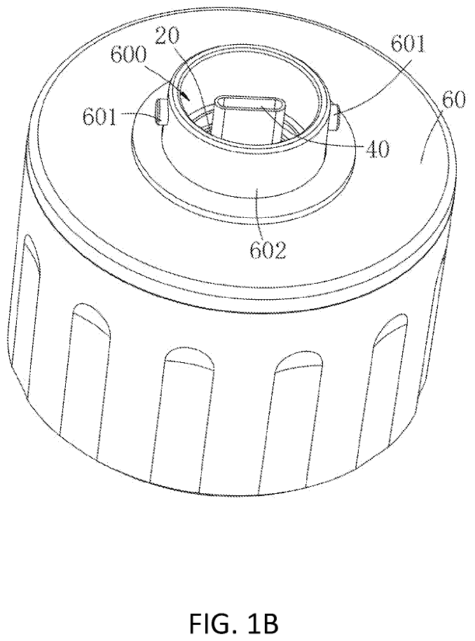

Specifically, referring to FIG. 1A and FIB. 1B of the drawings of the present invention, the Type-C receptacle load-bearing docking protection device is applied to the load-bearing docking type motion sensor with Type-C receptacle as an example, illustrating structure of a load-bearing docking type motion sensor with Type-C receptacle and a respective sensor mounting base according to a preferred embodiment of the present invention, wherein the Type-C receptacle load-bearing docking protection device includes a first receptacle mounting base 10, a second receptacle mounting base 20, and a first Type-C receptacle 30, a second Type-C receptacle 40, a first load-bearing docking housing 50, and a second load-bearing docking housing 60, wherein the first Type-C receptacle 30 and the second Type-C receptable 40 are paired and matched as male receptacle and female receptacle respectively, wherein the first Type-C receptacle 30 is fixedly installed to the first receptacle mounting base 10, and the second Type-C receptacle 40 is fixedly installed to the second receptacle mounting base 20, wherein the first load-bearing docking housing 50 and the second load-bearing docking housing 60 are arranged to be matched with each other so as to be able to bear loading in an unplugging direction of the first Type-C receptacle 30 and the second Type-C receptacle 40, such that the second Type-C receptacle 40 and the first Type-C receptacle 30 cannot be loosened in an unplugging direction with each other due to gravity while the first load-bearing docking housing 50 and the second load-bearing docking housing 60 are docked with each other, wherein the first receptable mounting base 10 is installed in the first load-bearing docking housing 50 and the second receptable mounting base 20 is installed in the second load-bearing docking housing 60. At least one receptacle mounting base 10/20 of the first receptacle mounting base 10 and the second receptacle mounting base 20 is arranged in a repositionable and movable manner with respect to the corresponding first or second load-bearing docking housing 50/60, so that a docking action between the first load-bearing docking housing 50 and the second load-bearing docking housing 60 can be implemented in a state while the first Type-C receptacle and the second Type-C receptacle are interplugging together. In addition, during the movable docking action between the first load-bearing docking housing 50 and the second load-bearing docking housing 60 is performed, the docking stability of the second Type-C receptacle 40 with respect to the first Type-C receptacle 30 is ensured. Also, while one of the first load-bearing docking housing 50 and the second load-bearing docking housing 60 is used as a housing of the load-bearing docking type motion sensor with Type-C receptacle, the plugging and connecting stability of the load-bearing docking type motion sensor with Type-C receptacle and the relative apparatus is guaranteed.

It is worth mentioning that at least one receptacle mounting base 10/20 of the first receptacle mounting base 10 and the second receptacle mounting base 20 is arranged in a repositionable and movable manner with respect to the corresponding first or second load-bearing docking housing 50/60, so that when the movement between the first load-bearing docking housing 50 and the second load-bearing docking housing 50 and the second load-bearing docking housing releases the mutual docking condition between the first load-bearing docking housing 50 and the second load-bearing docking housing 60, the movement occurred during the movable docking action between the first load-bearing docking housing 50 and the second load-bearing docking housing 60 with respect to the arrangement of the corresponding load-bearing docking housing 50/60 in the repositionable and movable manner between the respective receptacle mounting base 10/20 and the respective load-bearing docking housing 50/60 is able to be repositioned and be retained in the reposition condition. Correspondingly, an active docking structure between the first load-bearing docking housing 50 and the second load-bearing docking housing 60 is able to maintain independence with respect to the mutual plugging and connecting structure between the first load-bearing docking housing 50 and the second load-bearing docking housing 60, and thus during the repeatedly plugging and connecting process between the first load-bearing docking housing 50 and the second load-bearing docking housing 60, the docking precision of the first Type-C receptacle 30 and the second Type-C receptacle 40 is ensured, so that when the Type-C receptacle load-bearing docking protection device is able to be applied to load-bearing cable docking between the load-bearing docking type motion sensor with Type-C receptacle and the relative apparatus (such as lamp, power source, power supply socket), the repeatedly plugging installation and unplugging uninstallation between the load-bearing docking type motion sensor with Type-C receptacle and the relative apparatus can easily be implemented.

Further, at least one receptacle mounting base 10/20 of the first receptable mounting base 10 and the second receptable mounting base 20 is arranged in a repositionable and movable manner with respect to the corresponding load-bearing docking housing 50/60, so as to ensure the movable docking structure between the first load-bearing docking housing 50 and the second load-bearing docking housing 60 with respect to mutual docking structure between the first receptable mounting base 10 and the second receptacle mounting base 20 maintains independence, so as to adapt different structural design requirements and reduce the interdependence of the movable docking structure between the first load-bearing docking housing 50 and the second load-bearing docking housing 60 and the docking structure between the first receptable mounting base and the second receptable mounting base 20, and thus reducing the matching accuracy 10 requirements of the movable docking structure between the first load-bearing docking housing 50 and the second load-bearing docking housing 60 and the docking structure between the first receptacle mounting base 10 and the second receptacle mounting base 20.

In particular, in an application of the Type-C receptacle load-bearing docking protection device as illustrated in FIG. 1A and FIG. 1B, the second receptable mounting base 20 is arranged in a repositionable and rotatable manner in the second load-bearing docking housing 60, and the first receptable mounting base 10 is fixedly installed in the first load-bearing docking housing 50, wherein the first load-bearing docking housing 50 has at least one guiding groove 501 extending in a plugging direction of the first Type-C receptacle 30 and a docking groove 502 extending from a bottom of in a lateral direction of the guiding groove 501 integrally, wherein the second load-bearing docking housing 60 has at least one guide docking protrusion 601 provided in a plugging direction of the second Type-C receptacle 40 and the first Type-C receptacle 30, such that when the guide docking protrusion 601 is aligned with a groove opening of the guiding groove 501, an alignment of the first Type-C receptacle 30 and the second Type-C receptacle 40 is maintained in the direction of the mutual plugging and connection thereof, and that corresponding to the plugging process of the first Type-C receptacle 30 and the second Type-C receptacle 40, the guide docking protrusion 601 slides along the guiding groove 501, so that based on the guidance of the guiding slot 501 relative to the guide docking protrusion 601, the positioning and plugging of the first Type-C receptacle 30 and the second Type-C receptacle 40 are implemented while the Type-C receptacle 30 and the second Type-C receptacle 40 is obscured by the corresponding load-bearing docking housings 50/60. In addition, when the first Type-C receptacle 30 and the second Type-C receptacle 40 is in plugged-in state, further based on the structural state that the second docking mounting base 20 is installed in the second load-bearing docking housing 60 in a repositionable and rotatable manner, the rotating docking movement between the first load-bearing docking housing 50 and the second load-bearing docking housing 60 can be further implemented. Correspondingly, based on the rotation movement of the first load-bearing docking housing 50 with respect to the second load-bearing docking housing 60, the guide docking protrusion 601 of the second load-bearing docking housing 60 slides along the docking groove 502 to implement the rotating docking of the first load-bearing docking housing 50 and the second load-bearing docking housing 60.

In addition, referring to FIG. 1A and FIG. 1B, the Type-C receptacle load-bearing docking protection device is illustrated in an application form. There are two guide docking protrusions 601, wherein the two guide docking protrusions 601 are provided on the second load-bearing docking housing 60 in a symmetrical manner, wherein the Type-C male receptacle and the Type-C female receptacle are arranged to match with each other in receptacle forms of the first Type-C receptacle 30 and the second Type-C receptacle 40 respectively. An opening shape of each of the first and second Type-C receptacles 30/40 satisfies a vertical symmetry line and a horizontal symmetry line that are perpendicular to each other. That is the opening shape of each of the first and second Type-C receptacles 30/40 is symmetrical with the vertical symmetry line and the horizontal symmetry line, wherein the two guide docking protrusions 601 are preferably arranged on the second load-bearing docking housing 60 symmetrically with the vertical symmetry line and the horizontal symmetry line, so that the docking between the first load-bearing docking housing 50 and the second load-bearing housing 60 also has a structural feature of unlimiting to front and back plugging while the second receptacle mounting base 20 is installed in the second load-bearing docking housing 60 in a repositionable and rotatable manner.

Further, in such application form of the Type-C receptacle load-bearing docking protection device as illustrated FIG. 1A and FIG. 1B, the first load-bearing docking housing 50 includes a first docking ring 503 which defines a first docking chamber 500. The second load-bearing docking housing 60 includes a second docking ring 602 which defines a second docking chamber 600, wherein the first Type-C receptacle 30 is fixedly installed in the first receptable mounting base 10 while surrounding by the first docking ring 503, and the second Type-C receptacle 40 is fixedly installed in the second receptable mounting base 20 while surrounding by the second docking ring 603, wherein the guiding grooves 501 and the docking groove 502 formed in an inner wall of the first docking ring 503 are provided in the first docking chamber 500 and guide docking protrusions 601 protruded and extended on an outer wall of the second docking ring 602 are provided in the second docking chamber 600.

In particular, while the first and second Type-C receptacles 30/40 are surrounded by the corresponding first and second docking rings 503/602 respectively, the corresponding shapes of the first and second docking rings 503/602 are symmetrical with the vertical symmetry line as well as the horizontal symmetry line, so that the engagement between the first docking ring 503 and the second docking ring 602 also has a structural feature of unlimiting to front and back plugging and connecting, and that based on the engaging movement of the first docking ring 503 and the second docking ring 602, the positioning and plugging of the first Type-C receptacle 30 and the second Type-C receptacle 40 are able to be implemented while the first Type-C receptacle 30 and the second Type-C receptacle 40 are obscured by the corresponding first and second docking rings 503/602, so as to facilitate a rapid plugging between the first Type-C receptacle 30 and the second Type-C receptacle 40.

It is worth mentioning that, in such application state of the Type-C receptacle load-bearing docking protection device as illustrated in FIG. 1A and FIG. 1B, both the first docking ring 503 and the second docking ring 602 are protruded from the corresponding first and second load-bearing docking housings 50/60 respectively. The structural arrangement of the first docking ring 503 and the second docking ring 602 can also be inside-outside exchangeable, which is not limited in the present invention.

Corresponding to the inside-outside exchanged structural arrangement of the first docking ring 503 and the second docking ring 602, the guiding groove 501 and the docking groove 502 are formed in the outer wall of the first docking ring 503 in the first docking chamber 500, and the guide docking protrusion 601 is protruded and extended on the inner wall of the second docking ring 602 within the second docking chamber 600, which is not limited in the present invention.

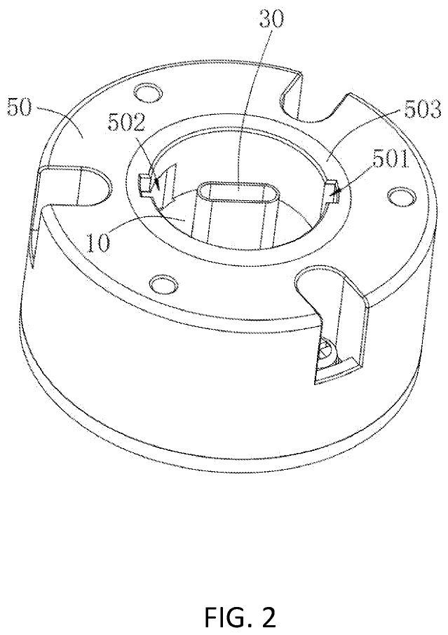

In particular, in some embodiments of the present invention, based on the application form of the Type-C receptacle load-bearing docking protection device as illustrated in FIG. 1A and FIG. 1B, the first docking ring 503 can alternatively be formed recessedly in the first load-bearing docking housing 50, referring to FIG. 2, that is not limited in the present invention.

In addition, referring to FIG. 2, while the first docking ring 503 is recessedly arranged in the first load-bearing docking ring housing 50, the structural arrangement of the first docking ring 503 and the second docking ring 602 are inside-outside exchangeable. Corresponding to the inside-outside exchanged structural arrangement of the first docking ring 503 and the second docking ring 602, the guiding groove 501 and the docking groove 502 are formed in the outer wall of the second docking ring 602 in the second docking chamber 600, and the guiding protrusions 601 are protruded on the inner wall of the first docking ring 503 in the first docking chamber 500.

It is worth mentioning that, while the first load-bearing docking housing 50 and the second load-bearing docking housing 60 are in a docking state, a waterproof/dustproof gasket can be selectively provided between the first load-bearing docking housing 50 and the second load-bearing docking housing 60, so as to ensure a waterproof/dustproof ability between the first load-bearing docking housing 50 and the second load-bearing docking housings 60 in the docking state. For example, by providing a waterproof/dustproof gasket provided between the first docking ring 503 and the second load-bearing docking housing 60, and/or providing a waterproof/dustproof gasket between the second docking ring 602 and the first load-bearing docking housing 50 while the first load-bearing docking housing 50 and the second load-bearing docking housing 60 are in the docking state, based on a pressing of the waterproof/dustproof gasket by the first load-bearing docking housing 50 and the second load-bearing docking housing 60, the waterproof/dustproof ability between the first load-bearing docking housing 50 and the second load-bearing docking housing 60 in the docking state is ensured.

Further, one load-bearing docking housing 50/60 of the first load-bearing docking housing 50 and the second load-bearing docking housing 60 is arranged to be a housing of a load-bearing docking type motion sensor with Type-C receptacle, while the other load-bearing docking housing 50/60 of the first load-bearing docking housing 50 and the second load-bearing docking housing 60 is arranged to be a housing of a relative apparatus (lamp, power supply, power socket, independent sensor mount), such that the load-bearing docking type motion sensor with the Type-C receptacle can be installed in the relative apparatus with the Type-C receptacle as a standard receptacle for cable docking and connection based on the Type-C receptacle load-bearing docking protection device.

In the embodiment of the present invention, specifically, the second load-bearing docking housing 60 is used as the housing of the load-bearing docking type motion sensor with Type-C receptacle as an example, and the first load-bearing docking housing 50 is correspondingly used as the housing of the load-bearing docking type motion sensor with Type-C receptacle as an example.

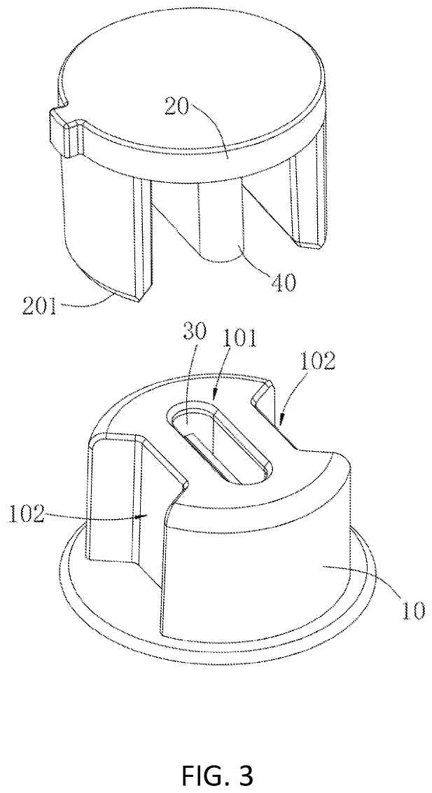

Further referring to FIG. 3, the improved structure of the Type-C receptacle load-bearing docking protection device is partially exemplified. Specifically, the first Type-C receptacle 30 is fixedly installed in the first receptacle mounting base 10 by being embedded in the first receptable mounting base 10, wherein an opening of the first Type-C receptacle 30 is oriented in a height direction of the first receptacle mounting base 10. The first receptacle mounting base 10 has a plug-in limiting surface 101 raised in the height direction thereof and at least one movement limiting groove 102 positioned at a side position of the first Type-C receptacle 30 and extended in a plugging direction of the first Type-C receptacle 30. The second Type-C receptacle 40 is fixedly mounted on the second receptable mounting base 20, wherein an opening of the second Type-C receptacle 40 is oriented in a height direction of the second receptable mounting base 20. The second receptable mounting base 20 has at least one movement limiting member 201 positioned at a side position of the second Type-C receptacle 40 and extended in the plugging direction in the height direction thereof, wherein the at least one movement limiting member 201 is sized and shaped structurally matching with the at least one movement limiting groove 102 and is preferably higher than an opening of the Type-C receptacle 40, wherein when the first Type-C receptacle 30 is aligned with the second Type-C receptacle 40 along the plugging direction of the first Type-C receptacle 30 and the second Type-C receptacle 40, the opening of the at least one movement limiting groove 102, located on the plug-in limiting surface 101 is maintained being aligned with the movement limiting member 201. Accordingly, during the engaging of the first docking ring 503 and the second docking ring 602, by means of the insertion and positioning of the movement limiting member 201 and the movement limiting groove 102, the alignment and positioning of the first Type-C receptacle 30 and the second Type-C receptacle 40 are further ensured, and that by means of the butting between the first Type-C receptacle 30 and the second Type-C receptacle 40 and/or the abutment between the plug-in limiting surface 101 and the and the second receptacle mounting base 20 along the plugging direction of the first Type-C receptacle 30 and the second Type-C receptacle 40, a protection to limit a plugging depth of the first Type-C receptacle 30 and the second Type-C receptacle 40 is implemented. In addition, by means of the docking of the at least one movement limiting member 201 and the at least one movement limiting groove 102 provided at lateral sides of the first Type-C receptacle 30 and the second Type-C receptacle 40, the relative lateral movement of the first Type-C receptacle 30 and the second Type-C receptacle 40 is limited and protected. Furthermore, during the engaging of the first docking ring 503 and the second docking ring 602, the docking precision and stability of the first Type-C receptacle 30 and the second Type-C receptacle 40 are further guaranteed.

It should be understood that the movement limiting groove 102 can be a laterally open groove as illustrated in FIG. 3, or a laterally closed perforated groove provided at the first receptacle mounting base 10, which is not limited in the present invention.

In particular, according to the improved structure of the Type-C receptacle load-bearing docking protection device illustrated in FIG. 3, there are two movement limiting members 201 and two corresponding movement limiting grooves 102, wherein the two movable limiters 201 are symmetrically provided at two lateral sides of the second Type-C receptacle 40 respectively such that the vertical symmetry line and the horizontal symmetry line are symmetrical, so that the second receptable mounting base 20 has the second Type-C receptacle 40 and a structural feature of having no restriction to front or back docking and plugging.

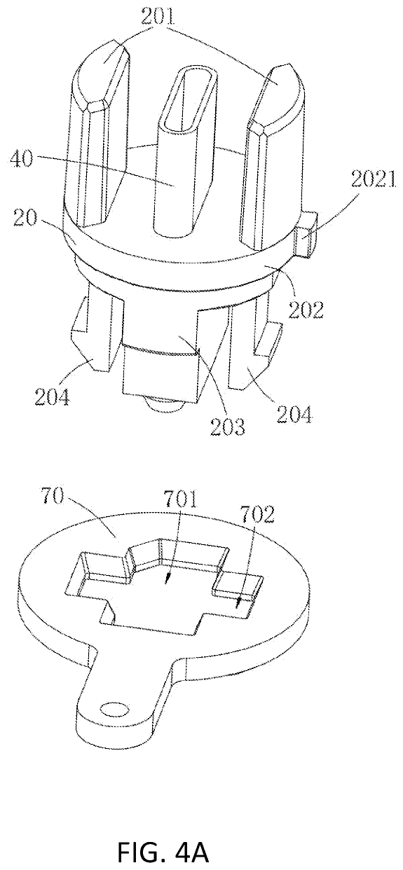

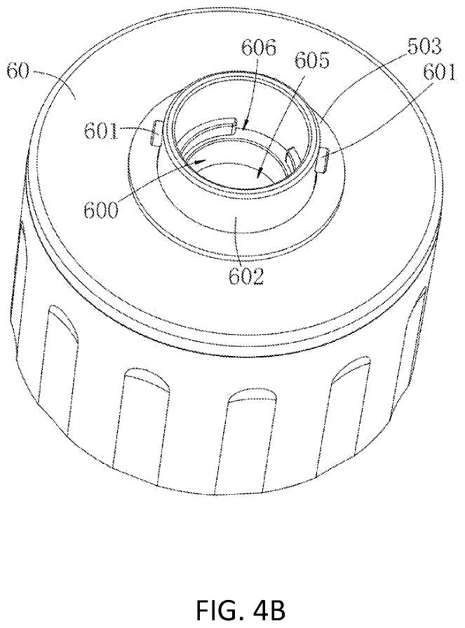

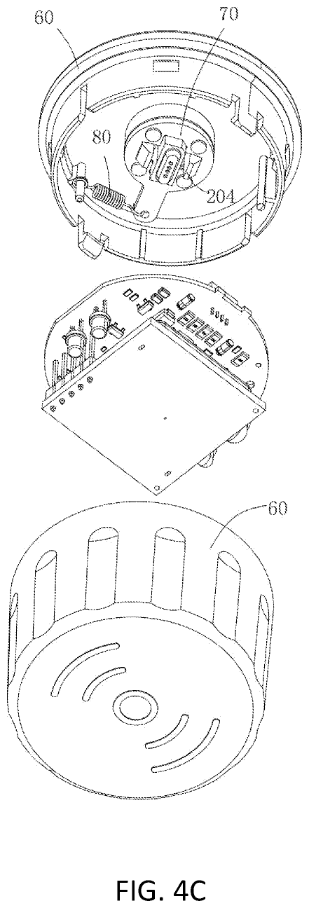

Further, referring to FIG. 4A to FIG. 4C of the present invention, a further improved structure of the Type-C receptacle load-bearing docking protection device as shown in FIG. 3 based on the application form of the Type-C receptacle load-bearing docking protection device as shown in FIG. 1A and FIG. 1B is illustrated, and the installation structure of the second receptacle mounting base 20 in the second load-bearing docking housing 60 is further illustrated. Specifically, in this embodiment of the present invention, the second receptable mounting base 20 is respositionable and rotatably mounted in the second load-bearing docking housing 60 and further links with a rotating linkage plate 70, wherein the rotating linkage plate 70 is stretchedly linked with a resilient element 80 arranged in the second load-bearing docking housing 60, so as to retain the second receptacle mounting base 20 at a stretched and restricted initial state while the second receptacle mounting base 20 is limitable and rotatably mounted in the second load-bearing docking housing 60. Correspondingly, when the second receptacle mounting base 20 is driven to rotate with respect to the second load-bearing docking housing 60 by an external force, that is, specifically, when the second receptacle mounting base 20 is driven to rotate with respect to the second load-bearing docking housing 60 due to the rotation docking movement of between the load-bearing docking housing 50 and the second load-bearing docking housing 60, the deformation of the resilient element 80 increases the force applied to the rotating linkage plate 70, so that when such external force applied to the second receptacle mounting base 20 is released, the rotating linkage plate 70 is able to be driven by the resilient element 80 to reset and maintain in its stretched and restricted initial state, such that the second receptacle mounting base 20 is mounted in the load-bearing docking housing 60 is the repositionable and rotatable manner.

In detail, the second receptable mounting base 20 further includes a bottom plate 202, a linkage member 203 and at least one engaging member 204, wherein the movement limiting member 201 is extended from the bottom plate 202 along a height direction of the second receptacle mounting base 20, and the linkage member 203 is extended from the bottom plate 202 along an opposite direction of an extending direction of the movement limiting member 201, wherein the rotating linkage plate 70 has a linkage slot 701 and at least one engaging slot 702, wherein the rotating linkage plate 70 is mounted in the second receptacle mounting base 20 in such a manner that the linkage member 203 is inserted in the linkage slot 701 and engaged with the rotating linkage plate 70 in the direction of inserting into the linkage groove 701, and the engaging member 204 is inserted into the linkage groove 701 and engaged with the rotating linkage plate in the unplugging direction from the engaging groove 702. Therefore, by means of the engagement of the linkage member 203 with the rotating linkage plate 70 in the direction of inserting into linkage groove 701, the movement of the second receptacle mounting base 20 in such direction with respect to the rotating linkage plate 70 is restricted, and that by means of the structure of the linkage member 203 inserted into the linkage groove 701, an engagement between the linkage member 203 and the groove wall of the linkage groove 701 is formed. Correspondingly, the rotating linkage plate 70 is linked and driven to rotate by a rotation state of second receptacle mounting base 20 with respect to the second load-bearing docking housing 60. In addition, based on the engagement between the engaging member 204 and the rotating linkage plate 70 in the direction of unplugging from the engaging groove 702, the second receptacle mounting base 20 is restricted from being unplugged from the rotating linkage plate 70 in that direction.

Further, the bottom plate 202 has a rotation limiting member 2021 protruding from the bottom plate 202 or recessed in the bottom plate 202, wherein the second load-bearing docking housing 60 has an installation channel 605 communicating with the second docking chamber 600, wherein while the second receptable mounting base 20 is mounted on the second load-bearing docking housing 60, the linkage member 203 is configured to be inserted into the installation channel 605 and the bottom plate 202 is abutted and docked with the second load-bearing docking housing 60 along the direction of the linkage member 203 inserting into the installation channel 605. The rotation limiting member 2021 of the bottom plate 202 is limited to rotate within a predetermined rotation stroke in a rotation direction of the second receptacle mounting base 20 by the second load-bearing docking housing 60 in the rotation direction of the second receptable mounting base 20, so that by mounting the second receptable mounting base 20 on the second load-bearing docking housing 60, installing the rotating linkage plate 70 at the second receptable mounting base 20, and stretchedly linking the resilient element 80 the rotating linkage plate 70 with the second load-bearing docking housing 60, the second receptacle mounting base 20 is limitable in position and rotatably mounted on the second load-bearing docking housing 60 in the stretched and restricted initial state.

Specifically, in this embodiment of the present invention, the bottom plate 202 is a circular bottom plate and the installation channel 605 is a circular channel, wherein a channel diameter of the installation channel 605 is smaller than a diameter of the bottom plate 202, so that, in the direction of inserting the linkage member 203 into the installation channel 605, the bottom plate 202 is docked and abutted in such direction against an channel opening, communicating with second docking chamber 600, of the installation channel 605 so as to form the structure of rotatably mounting the second receptacle mounting base 20 on the second load-bearing docking housing 60.

Further, the movement limiting member 2021 is formed at an edge of the bottom plate 202 by protruding thereon or recessing therein, including but not limiting to the side edge and lower edge (in the direction of inserting the linkage member 203 into the installation channel 605). A rotation limiting portion 606 in form of recess or protrusion correspondingly is defined at the channel opening communicating the installation channel 605 and the second docking chamber 600 of the second load-bearing docking housing 60, wherein while the second receptacle mounting base 20 is mounted on the second load-bearing docking housing 60, the rotation limiting member 2021 of the bottom plate 202, positioned at the rotation limiting portion 606, is limited within a predetermined rotation stroke by the rotation limiting portion 606 in the rotation direction of the second receptacle mounting base 20, so as to form the structure of rotatably mounting the second receptacle mounting base 20 on the second load-bearing docking housing 60 in a position limitable manner.

Specifically, according to the embodiment of the present invention, the rotation limiting member 2021 provided on the bottom plate 202 is protruded on the side edge of the bottom plate 202, and the rotation limiting portion 606 is provided at the channel opening communicating the installation channel 605 and the second docking chamber 600 of the second load-bearing docking housing 60 in form of a groove correspondingly, wherein while the second receptable mounting base 20 is installed on the second load-bearing docking housing 60, the rotation limiting member 2021 of the bottom plate 202 is positioned at the rotation limiting portion 606 so as to limit the rotation direction of the second receptable mounting base 20 within the predetermined rotation stroke by the rotation limiting portion 606, such that the structure of installing the second receptacle mounting base 20 in the second load-bearing docking housing 60 in a position limitable and rotatable manner is formed.

It is worth mentioning that there are various structural forms to install the second receptable mounting base 20 on second load-bearing docking housing 60 in a respositionable and rotatable manner and the present invention is not limited thereto. For example, in some embodiments of the present invention, the second receptable mounting base 20 is affixed to a relative housing in such a manner that, when the second load-bearing docking housing 60 is repositionably and rotatably installed on the housing, the second receptable mounting base 20 is also able to be equivalently installed to the second load-bearing docking housing 60 in a respositionable and rotatable manner.

It can be understood that, when the second receptable mounting base 20 is repositionably and movably installed on the second load-bearing docking housing 60, the connection between the second Type-C receptacle 40 fixed the second receptable mounting base 20 and the corresponding circuit board can be a flexible cable connection or a non-flexible cable connection while the corresponding circuit board is movably arranged in the second load-bearing docking housing 60. The present invention is not limited to this embodying example.

For example, when the Type-C receptacle load-bearing docking protection device is applied to the docking and connection between the load-bearing docking type motion sensor with the Type-C receptacle and the load-bearing circuit of the relative apparatus, the second load-bearing docking housing 60 is specifically embodied as a microwave sensor housing, and the corresponding circuit board can be fixedly arranged at the second load-bearing docking housing 60 to connect to second Type-C receptacle 40 through flexible cable or fixedly connected to second Type-C receptacle 40 so as to movably installed in the second load-bearing docking housing 60. The present invention does not limit to such embodying example. It is worth mentioning that while the corresponding circuit board is fixedly arranged in the second load-bearing docking housing 60 and connected to the second Type-C receptacle 40 through the flexible cable, two ends of the corresponding flexible cable can use standard receptacles to electrically connect with a terminal of the second Type-C receptacle 40 and a terminal of the corresponding circuit board respectively. The present invention does not limit to such embodying example.

It is worth mentioning that, according to the embodiment of the present invention, the first docking ring 503 and the second docking ring 602, which are matchingly adapted to be nestedly engaged in a docking direction of the first Type-C receptacle 30 and the second Type-C receptacle 40, are exemplified in shape of circular ring, wherein the first docking ring 503 and the second docking ring 602 illustrated in circular ring shape in the drawings should not constitute as limitation to the shape of the first docking ring 503 and second docking ring 602 of the present invention. For example, the matching ring shapes of the first docking ring 503 and the second docking ring 602 can also be designed in regular shape such as elliptical, rectangular, trapezoidal, triangular, rhombic, and etc. or irregular shape, which is not limited in the present invention.

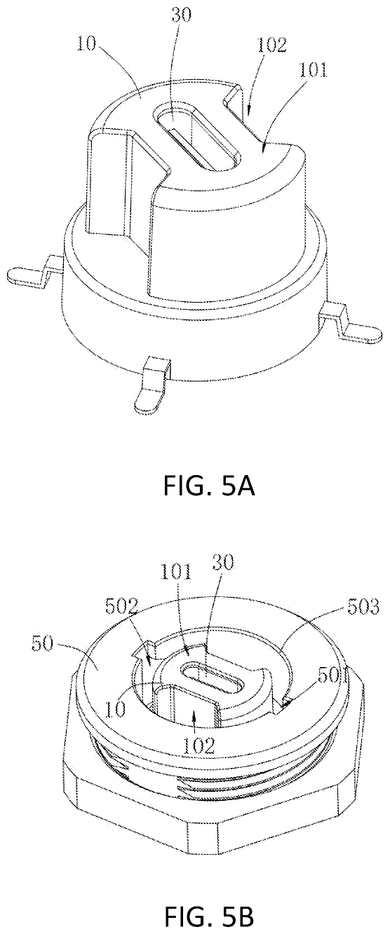

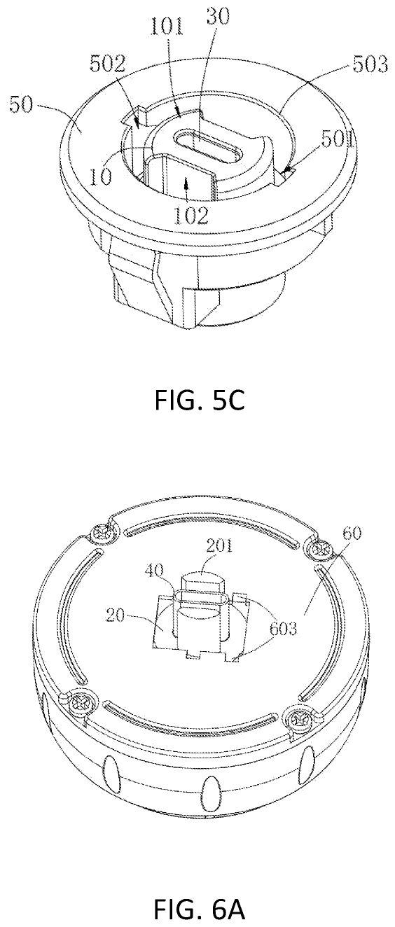

Further, referring to FIG. 5A of the drawings of the present invention, while the first receptable mounting base 10 is fixedly installed on the first load-bearing docking housing 50, the connection between the first receptable mounting base 10 and the first load-bearing docking housing 50 can be a fixed connection relationship, corresponding to FIG. 5A, that is a fixed connection formed between terminal pins extended from the first docking mounting base 10 and the corresponding plate of the first load-bearing docking housing 50, or a threaded connection formed between the first receptable mounting base 10 and the first load-bearing docking housing 50, or an engagement between the first receptable mounting base 10 and the first load-bearing docking housing 50, which is not limited in the present invention.

In addition, referring to FIG. 5B and FIG. 5C of the accompanying drawings of the present invention, while the corresponding docking mounting base 10/20 is fixedly installed on the corresponding load-bearing docking housing 50/60, a load-bearing docking module can be implemented with any above-mentioned fixed connection method or an integral fixed connection method between the corresponding docking mounting base 10/20 and the corresponding load-bearing docking housing 50/60, wherein the load-bearing docking module may not only be configured to utilize threaded connection method as shown in FIG. 5B for mounting with the threaded structure of the corresponding housing, but also be configured to utilize engagement connection method as shown in FIG. 5C for mounting with the engagement structure of the corresponding housing, such that the corresponding load-bearing docking housing 50/60 of the load-bearing docking module constitutes a part of the housing while the load-bearing docking module is installed to the corresponding housing.

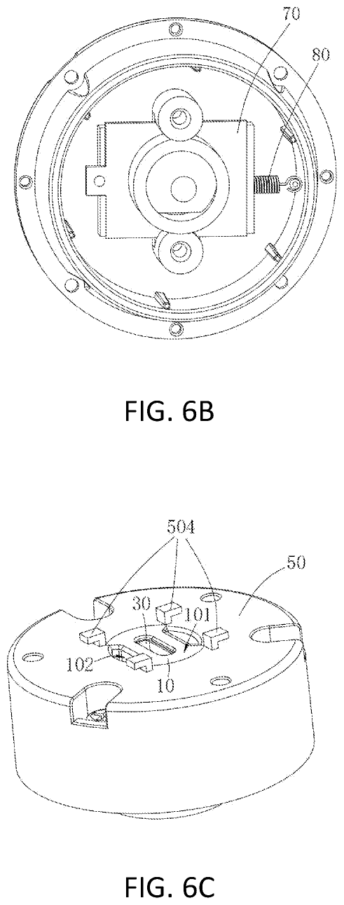

Further, referring to FIG. 6A to FIB. 6C of the accompanying drawings of the present invention, an alternative embodiment of docking structure between the first load-bearing docking housing 50 and the second load-bearing docking housing 60 is exemplified, wherein the second receptacle mounting base 20 is installed to the second load-bearing docking housing 60 in a repositionable and moveable manner, and the first receptacle mounting base 10 is fixedly installed to the first load-bearing docking housing 50. Specifically, in this embodiment of the present invention, the second receptable mounting base 20 is installed to the second load-bearing docking housing 60 in a repositionable and slidable manner and the first receptacle mounting base 10 is fixedly installed to the first load-bearing docking housing 50, wherein the first load-baring docking housing 50 has at least two engaging hooks 504 protruded from the first load-baring docking housing 50, and the second load-baring docking housing 60 has at least two engaging slots 603 configured to match with the at least two engaging hooks 50, wherein in the plugging direction of the second Type-C receptacle 40 and the first Type-C receptacle 30, while the opening of the at least one movement limiting groove 102 on the plug-in limiting surface 101 is aligned with the movement limiting member 201, the engaging hooks 504 and the engaging slots 603 are aligned with each other, so that, correspondingly, during a docking process of the first receptacle mounting base 10 and the second receptacle mounting base 20, the at least two engaging hooks 504 extend into the at least two engaging slots 603 respectively. In addition, according to the structure of repositionably and slidably installing the second receptacle mounting base 20 to the second load-bearing docking housing 60 while the first receptacle mounting base 10 is docked with the second receptacle mounting base 20, a sliding and docking movement can further be implemented between the first load-bearing docking housing 50 and the second load-bearing docking housing 60. With respect to a sliding movement between the first load-bearing docking housing 50 and the second load-bearing docking housing 60, the at least two engaging hooks 504 of the first load-baring docking housing 50 is displaced with the at least two engaging slots 603 of the second load-bearing docking housing 60 that forms a positioning limitation to the second load-bearing docking housing 60 with respect to the at least two engaging hooks 504 of the first load-bearing docking housing 50 in an unplugging direction of the first second Type-C receptacle 40 and the first Type-C receptacle 30, and thus a slidable docking between the first load-bearing docking housing 50 and the second load-bearing docking housing 60 is implemented. In which, during the side-sliding docking process of the first load-bearing docking housing 50 and the second load-bearing docking housing 60, the second receptacle 20 synchronously side-slides with respect to the second load-bearing docking housing 60, but by means of the resisting and docking between the movement limiting member 201 and the first receptacle mounting base 10 and/or between the plug-in limiting surface 101 and the second receptacle mounting base 20 in the plugging direction of the second Type-C receptacle 40 and the first Type-C receptacle 30, a plugging depth of the second Type-C receptacle 40 and the first Type-C receptacle 30 can thus be limited and protected. In addition, by means of the engaging and docking between movement limiting member 201 and the movement limiting groove 102 in a side orientation of the second Type-C receptacle 40 and the first Type-C receptacle 30, a side corresponding movement of the second Type-C receptacle 40 and the first Type-C receptacle 30 can be limited and protected. Accordingly, a docking stability of the second Type-C receptacle 40 and the first Type-C receptacle 30 is ensured during the side docking action between the first load-bearing docking housing 50 and the second load-bearing docking housing 60.

Furthermore, referring to FIG. 6B, according to the embodiment of the present invention, the second receptable mounting base 20 is installed to the second load-baring docking housing 60 in a side-sliding limiting manner, and further linked a side linkage plate 70, so as to enable the second receptacle mounting base 20 to correspondingly link the side linkage plate 70 while the second load-bearing docking housing 60 is in a side sliding condition, wherein the side linkage plate 70 is stressedly connected with a resilient element 80 arranged on the second load-bearing docking housing 60, so as to retain the second receptacle mounting base 20 in an stretched and restricted initial state while the second receptacle mounting base 20 is mounted on the second load-bearing docking housing 60 in a restricting and side slidable manner. Corresponding to a side sliding of the second receptacle mounting base 20 driven by an external force with respect to the second load-bearing docking housing 60, specifically, the second receptacle mounting base 20 is driven by the side sliding docking action between the first load-bearing docking housing 50 and the second load-bearing docking housing 60 to side slide with respect to the second load-bearing docking housing 60, the external force applied to the second receptacle mounting base 20 is released based on the increase of the force applied to the side linkage plate 70 due to the deformation of the resilient element 80, so that the side linkage plate 70 can be driven by the resilient element 70 to reposition and retain the second receptacle mounting base 20 to its initial state, so as to implement the repositionably and side slidably installing of the second receptacle mounting base 20 on the second load-bearing docking housing 60.

It is worth mentioning that there are various structural forms that can implement the installation of the second receptacle mounting base 20 to the second load-bearing docking housing 60 in a repositionable and slidable manner, which is not limited in the present invention.

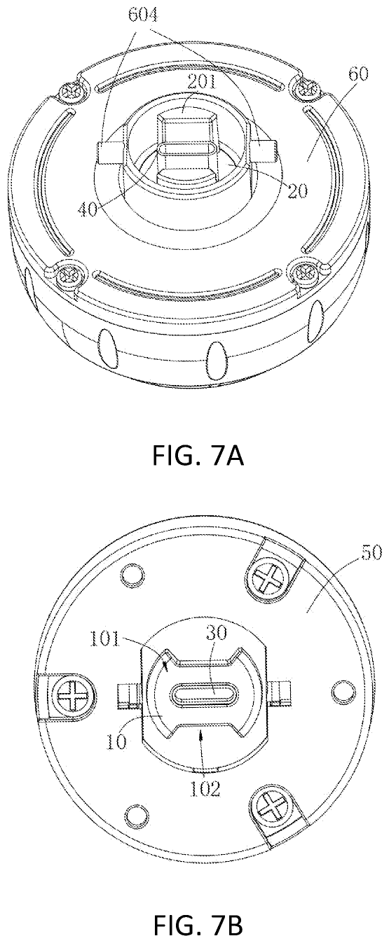

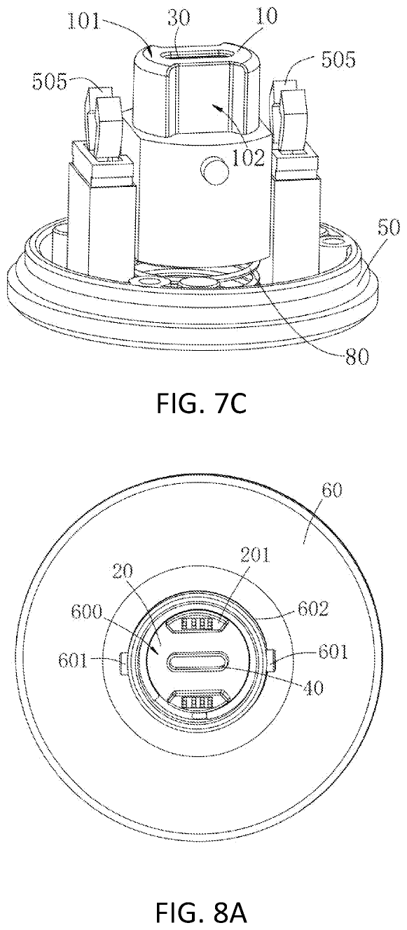

Further, referring to FIG. 7A to FIG. 7C of the accompanying drawings of the present invention, another docking structure between the first load-bearing docking housing 50 and the second load-bearing docking housing 60 while the second receptacle mounting base 20 is fixedly installed on the second load-bearing docking housing 60 and the first receptacle mounting base 10 is repositionably and moveably installed on the first load-bearing docking housing 50 is illustrated. Specifically, in this embodiment of the present invention, the second receptacle mounting base 20 is fixedly installed on the second load-bearing docking housing 60 and, while a resilient element 80 is arranged between the first receptacle mounting base 10 and the first load-baring docking housing 50, the first receptacle mounting base 10 is installed on the first load-bearing docking housing 50 in a repositionable and movable manner in a plugging direction of the second Type-C receptacle 40 and the first Type-C receptacle 30, wherein the first load-bearing docking housing 50 has at least one pushing lock 505 arranged thereon and the second load-bearing docking housing 60 has a locking bar 604 arranged thereon and configured to match with the pushing lock 505, wherein in the plugging direction of the second Type-C receptacle 40 and the first Type-C receptacle 30, the movement limiting groove 102 and the plug-in limiting surface 101 are aligned with each other and the at least one pushing lock 505 and the at least one locking bar 604 are aligned with each other. During the docking process of the first receptacle mounting base 10 and the second receptacle mounting base 20, based on the structural form that the first receptacle mounting base 10 is repositionably and movably installed on the first load-bearing docking housing 50 in the plugging direction of the second Type-C receptacle 40 and the first Type-C receptacle 30, the movable docking action between the first load-bearing docking housing 50 and the second load-bearing docking housing 60 in the plugging direction of the second Type-C receptacle 40 and the first Type-C receptacle 30 can be implemented. Based on the movable docking action between the first load-bearing docking housing 50 and the second load-bearing docking housing 60 in the plugging direction of the second Type-C receptacle 40 and the first Type-C receptacle 30, the pushing lock 505 of the first load-baring docking housing 50 can thus be pushed by the locking bar 604 of the second load-bearing docking housing 60 to form a docking limit for the pushing lock 505 and the locking bar 604 in the unplugging direction of the second Type-C receptacle 40 and the first Type-C receptacle 30, so as to implement the movable docking of the first load-bearing docking housing 50 and the second load-bearing docking housing 60. In which, during the movable docking process of the first load-bearing docking housing 50 and the second load-bearing docking housing 60, the first receptacle mounting base 10 is moved simultaneously with respect to the first load-bearing docking housing 50. However, due to the abutting limitation, in the plugging direction of the second Type-C receptacle 40 and the first Type-C receptacle 30, between the movement limiting member 201 and the first receptacle mounting base 10 and/or between the plug-in limiting surface 101 and the second receptacle mounting base 20, a plugging depth of the second Type-C receptacle 40 and the first Type-C receptacle 30 is able to be limited and protected. Therefore, during the implementing process of the movable docking action between first load-bearing docking housing 50 and the second load-bearing docking hosing 60, the docking stability of the second Type-C receptacle 40 and the first Type-C receptacle 30 is ensured.

It is worthing mentioning that, in the embodiment of the present invention, the movable docking action between the first load-baring docking housing 50 and the second load-bearing docking housing 60 and the docking action of the first receptacle mounting base 10 and the second receptacle mounting base 20 are in the same direction. However, based on the structural arrangement of installing the first receptacle mounting base 10 on the first load-bearing docking housing 50 in a repositionable and moveable manner in the plugging direction of the second Type-C receptacle 40 and the first Type-C receptacle 30, the movable docking action between the first load-bearing docking housing 50 and the second load-bearing docking housing 60 is allowed to have different action stroke with respect to the docking action the first receptacle mounting base 10 and the second receptacle mounting base 20. That is, while the first receptacle mounting base 10 is completely docked with second receptacle mounting base 20, the movable docking action of the first load-bearing docking housing 50 and the second load-bearing docking housing 60 in the plugging direction of the second Type-C receptacle 40 and the first Type-C receptacle 30 can be further implemented, so that the movable docking structure between the first load-bearing docking housing 50 and the second load-bearing docking housing 60 is able to be maintained independent with respect to the mutual docking structure of the first receptacle mounting base 10 and the second receptacle mounting base 20 so as to accommodate different structural design requirements and reduce mutual dependence of the movable docking structure between the first load-bearing docking housing 50 and the second load-bearing docking housing 60 and the docking structure of the first receptacle mounting base 10 and the second receptacle mounting base 20. Correspondingly, the matching accuracy requirement of the movable docking structure between the first load-bearing docking housing 50 and the second load-bearing docking housing 60 and the docking structure of the first receptacle mounting base 10 and the second receptacle mounting base 20 is reduced accordingly.

It is also worth mentioning that there are various structural forms that can implement the installation of the first receptable mounting base 10 to the first load-bearing docking housing 50 in the plugging direction of the second Type-C receptacle 40 and the first Type-C receptacle 30, which is not limited in the present invention.

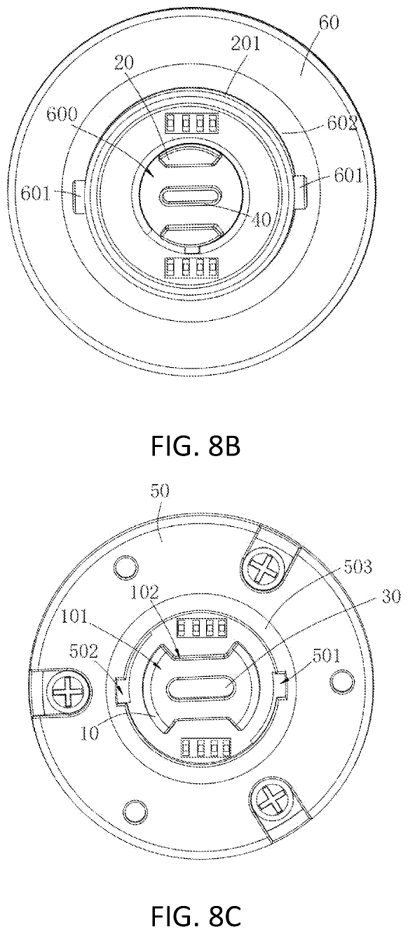

In particular, corresponding to the various application arrangements of the Type-C receptacle load-bearing docking protection device, according to different functions and/or parameter adjustment requirements, the Type-C receptacle load-bearing docking protection device optionally further has an input unit installation position for providing an input unit installation position of dial code switch, rotary encoding switch (BCD encoding switch), multi-gear switch, dial gear switch, adjustable potentiometer, and etc., wherein the input unit installation position is preferably positioned at the first docking chamber 500 and the second docking chamber 600. For example, to the dial code switch, the input unit installation position is able to be positioned at a terminal surface of the movement limiting member 201, or at the plug-in limiting surface 101, such as the terminal surface of the movement limiting surface 201 as shown in FIG. 8A. Alternatively, the first docking chamber 500 or the second docking chamber 600 may also be positioned at the first load-bearing docking housing 50 or the second load-bearing docking housing correspondingly. For example, as illustrated in FIG. 8B, the second docking chamber 600 is positioned at the second load-bearing docking housing 60, or as illustrated in FIG. 8C, the first docking chamber 500 is positioned at a bottom surface of the second receptacle mounting base 20, so as to enclose the input unit installation position within a closed chamber defined by the first docking ring 503 and the second docking ring 602 while the first load-bearing docking housing 50 and the second load-bearing docking housing 60 are docked with each other. Accordingly, the waterproof, dustproof and anti-contact protection of the input unit installed at the input unit installation position are implemented.

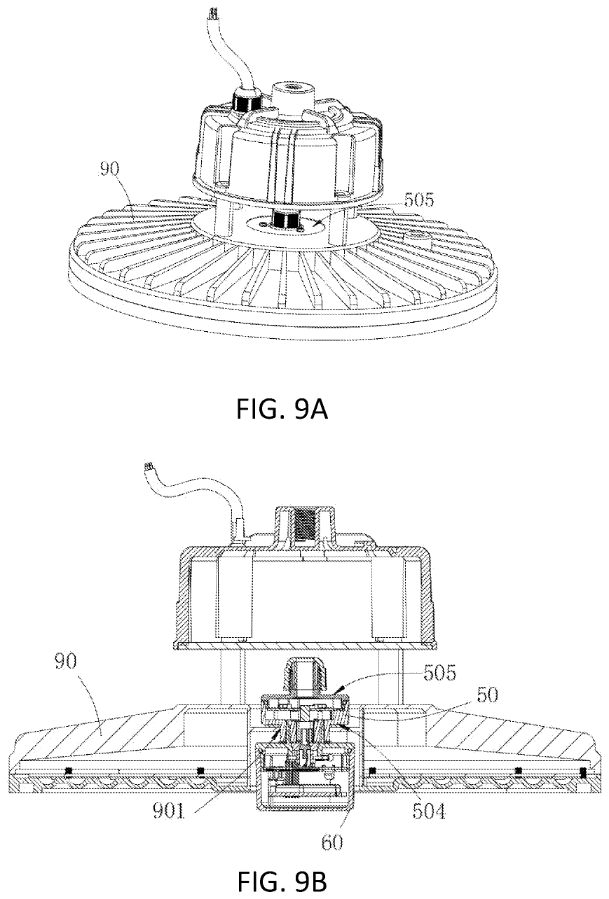

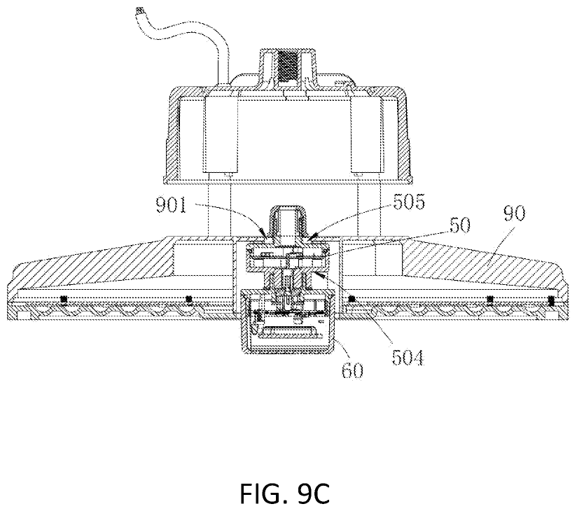

Further referring to FIG. 9A to FIG. 9C of the accompanying drawings of the present invention, the Type-C receptacle load-bearing docking protection device is applied to a load-bearing docking type motion sensor with Type-C receptacle and a lamp as exemplified embodiment, wherein the second load-bearing docking housing 60 is embodied as a microwave sensor installation housing.

Specifically, according to this application example of the present invention, the lamp housing 90 has a reserved channel 901 communicating inside with outside, wherein the first load-bearing docking housing 50 has a docking surface 504 and an outlet surface 505 with respect to the docking surface 504, wherein the docking surface 504 is a surface where the first load-bearing docking housing 50 docking with the second load-bearing docking housing 60 and facing the second load-bearing docking surface 60, wherein the first load-bearing docking housing 50 can be installed to the lamp housing 90 with the docking surface 504 facing the interior of the lamp housing 90 as illustrated in FIG. 9B while the docking surface 504 is connected with the lamp housing 90 at an channel opening of the reserved channel 901, or can be installed to the lamp housing 90 with the outlet surface 505 facing the exterior of the lamp housing 90 as illustrated in FIG. 9C while the outlet surface 505 is connected with the lamp housing 90 at the channel opening of the reserved channel 901.

Preferably, referring to FIG. 9B and FIG. 9C, when the first load-bearing docking housing 50 is installed to the lamp housing 90 with the docking surface 504 facing the interior of the lamp housing 90 as illustrated in FIG. 9B while the docking surface 504 is connected with the lamp housing 90 at an channel opening of the reserved channel 901, a waterproof/dustproof washer is arranged between the docking surface 504 of the first load-bearing docking housing 50 at the channel opening of the reserved channel 901 and the lamp housing 90. When the first load-bearing docking housing 50 is installed to the lamp housing 90 with the outlet surface 505 facing the exterior of the lamp housing 90 as illustrated in FIG. 9C while the outlet surface 505 is connected with the lamp housing 90 at the channel opening of the reserved channel 901, a waterproof/dustproof washer is arranged between the outlet surface 505 of the first load-bearing docking housing 50 at the channel opening of the reserved channel 901 and the lamp housing 90. Therefore, by installing the first load-bearing docking housing 50 to the lamp housing 90 at the channel opening of the reserved channel 901, the waterproof/dustproof ability of the lamp housing 90 is ensured.

It is worth mentioning that, in the embodiment of the present invention, on the basis of the structure of the lamp housing 90 as shown in FIG. 9A to FIG. 9C, the first load-bearing docking housing 50 is optionally implemented as driver power housing to reduce external wiring, which is beneficial to ensure the waterproof performance of the corresponding lamp and reduce the cost of the lamp.

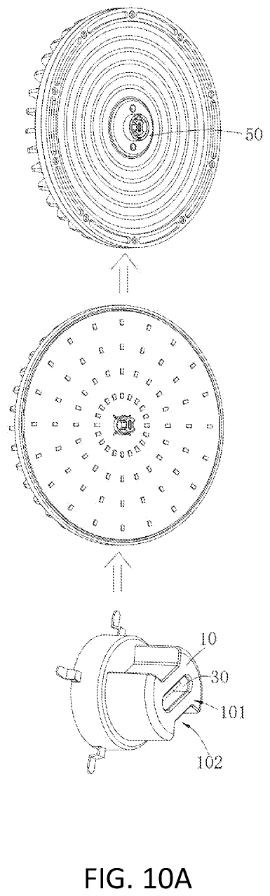

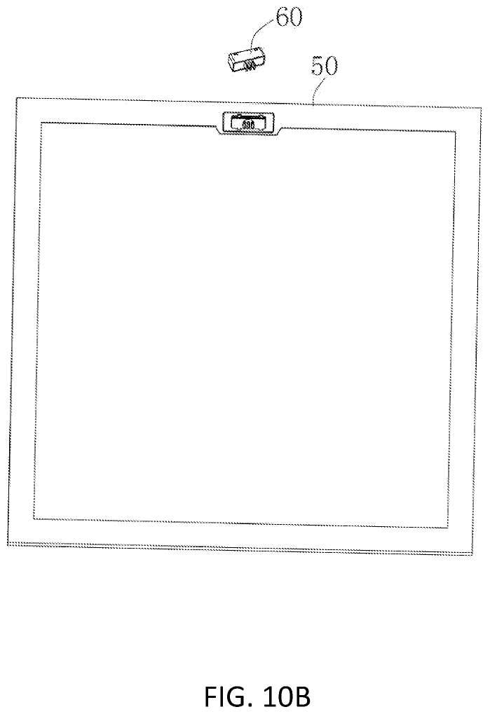

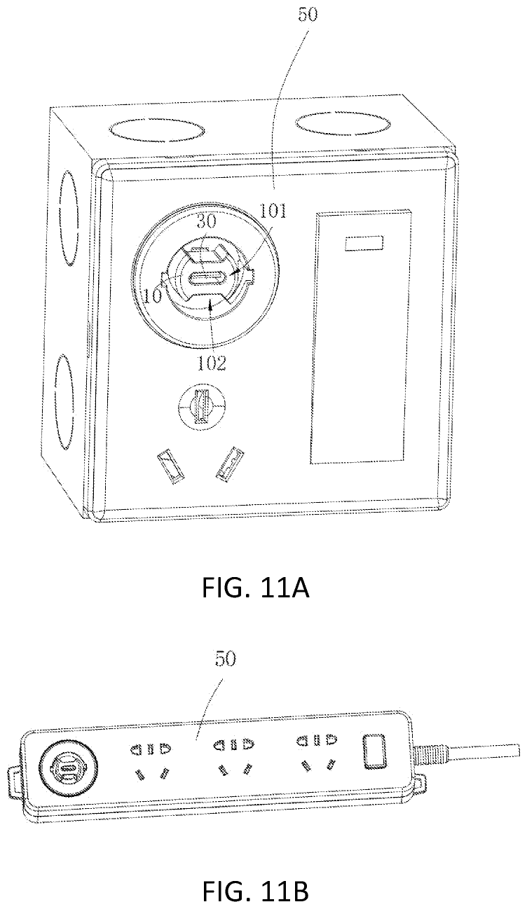

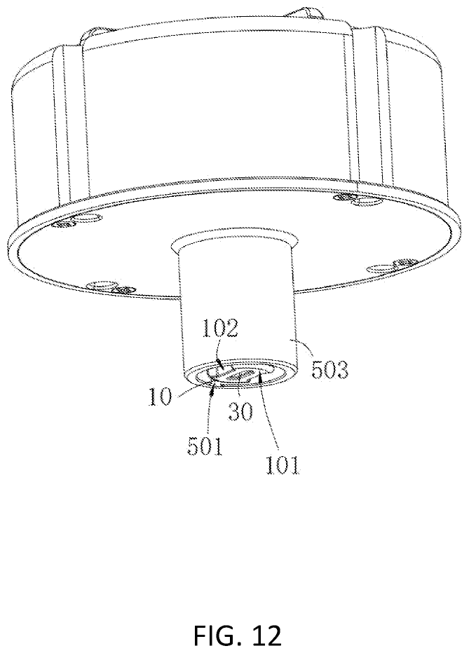

In particular, according to the above embodiments of the present invention, corresponding to the different application forms of the Type-C receptacle load-bearing docking protection device, the first load-bearing docking housing 50 may be a lamp housing, such as the inner housing of the lamp as shown in FIG. 10A and the outer housing of the lamp as shown in FIG. 10B, or may be a power socket housing for alternate current and/or direct current power supply, such as a wall socket housing as shown in FIG. 11A and the portable socket housing as shown in FIG. 11B, or a power supply housing, wherein the power supply housing includes AC/DC power supply housing, DC/DC power supply housing, stabilized power supply housing, switching power supply housing, emergency power supply housing, and other power supply housings with power supply functions, for example the driver power housing as illustrated in FIG. 12. Correspondingly, the second load-bearing docking housing 60 may be a microwave sensor housing, or a pyroelectric infrared sensor housing, and vice versa.

In the description of the specification, reference is made to the terms “one embodiment”, “some embodiments”, “example”, “specific example”, or “some examples” and etc. means specific features, structure, material or characteristic described in conjunction with the embodiment or example is included in the embodiment or example of the present invention. In the specification, the schematic representations of the above terms are not necessarily directed to the same embodiment or example. Furthermore, the described specific features, structures, materials or characteristics may be combined in any appropriate manner in any one or more embodiments or examples. In addition, those skilled in the art may combine or associate different embodiments or examples or the features described different embodiments or examples in the specification.

It should be understood by those skilled in the art that the embodiments of the present invention shown in the foregoing description and drawings are only examples and do not limit the present invention. The objects of the present invention have been fully and effectively accomplished. The function and structural principles of the present invention have been shown and described in the embodiments, and the embodiments of the present invention can have any deformation or modification without departing from the principles.

1. A Type-C receptacle load-bearing docking protection device, including:
a first receptacle mounting base;
a second receptacle mounting base;
a first Type-C receptacle and a second Type-C receptacle which are configured to match to each other in form of a Type-C male receptacle and a Type-C female receptacle respectively, wherein the first Type-C receptacle is fixedly installed to the first receptable mounting base and the second Type-C receptacle is fixedly installed to the second receptable mounting base;
a first load-bearing docking housing and a second load-bearing docking housing, wherein the first load-bearing docking housing and the second load-bearing docking housing are arranged to match to each other to be adapted for docking with each other so as to be able to bear loading in an unplugging direction of the first Type-C receptacle and the second Type-C receptacle, wherein the first receptable mounting base is installed to the first load-bearing docking housing and the second receptable mounting base is installed to the second load-bearing docking housing, wherein at least one receptacle mounting base of the first receptacle mounting base and the second receptacle mounting base is arranged in a repositionable and movable manner with respect to one load-bearing ducking housing of the first load-bearing docking housing and the second load-bearing docking housing correspondingly, so that a movable docking action between the first load-bearing docking housing and the second load-bearing docking housing is able to be implemented in a state while the first Type-C receptacle and the second Type-C receptacle are interplugging together, when a movement between the first load-bearing docking housing and the second load-bearing docking housing releases a mutual docking condition between the first load-bearing docking housing and the second load-bearing docking housing, a displacement occurred between the at least one receptacle mounting base arranged in the repositionable and movable manner and the at least one load-bearing docking housing during the movable docking action of the first load-bearing docking housing and the second load-bearing docking housing is able to be restored and repositioned and be retained in a repositioned condition.

2. The Type-C receptacle load-bearing docking protection device, as recited in claim 1, wherein the at least one receptacle mounting base of the first receptacle mounting base and the second receptacle mounting base is arranged in a repositionable and rotatable manner with respect to the at least one load-bearing docking housing of the first load-bearing docking housing and the second load-bearing docking housing.

3. The Type-C receptacle load-bearing docking protection device, as recited in claim 2, wherein the first load-bearing docking housing has at least one guiding groove extending in a plugging direction of the first Type-C receptacle and a docking groove extending from a bottom of in a lateral direction of the guiding groove integrally, wherein the second load-bearing docking housing has at least one guide docking protrusion provided in the plugging direction of the second Type-C receptacle and the first Type-C receptacle, such that when the at least one guide docking protrusion is aligned with a groove opening of the at least one guiding groove, an alignment of the first Type-C receptacle and the second Type-C receptacle is maintained in a direction of a mutual plugging and connection thereof, and that corresponding to a plugging process of the first Type-C receptacle and the second Type-C receptacle, the at least one guide docking protrusion slides along the at least one guiding groove, wherein based on a rotation movement of the first load-bearing docking housing with respect to the second load-bearing docking housing, the at least one guide docking protrusion of the second load-bearing docking housing slides along the at least one docking groove to implement a rotating docking of the first load-bearing docking housing and the second load-bearing docking housing.

4. The Type-C receptacle load-bearing docking protection device, as recited in claim 3, wherein a shape of an opening of each of the first and second Type-C receptacles satisfies a vertical symmetry line and a horizontal symmetry line that are perpendicular to each other, the at least one guide docking protrusion and another guide docking protrusion being arranged symmetrically with the vertical symmetry line and the horizontal symmetry line on the second load-bearing docking housing.

5. The Type-C receptacle load-bearing docking protection device, as recited in claim 4, wherein the first load-bearing docking housing includes a first docking ring which defines a first docking chamber and the second load-bearing docking housing includes a second docking ring which defines a second docking chamber, wherein the first Type-C receptacle is fixedly installed in the first receptable mounting base while surrounding by the first docking ring, and the second Type-C receptacle is fixedly installed in the second receptable mounting base while surrounding by the second docking ring, wherein the at least one guiding groove and the docking groove formed in an inner wall of the first docking ring are provided in the first docking chamber and the at least one guide docking protrusion and the another guide docking protrusion protruded and extended on an outer wall of the second docking ring are provided in the second docking chamber.

6. The Type-C receptacle load-bearing docking protection device, as recited in claim 4, wherein the first load-bearing docking housing includes a first docking ring which defines a first docking chamber and the second load-bearing docking housing includes a second docking ring which defines a second docking chamber, wherein the first Type-C receptacle is fixedly installed in the first receptable mounting base while surrounding by the first docking ring, and the second Type-C receptacle is fixedly installed in the second receptable mounting base while surrounding by the second docking ring, wherein the at least one guiding groove and the docking groove formed in an outer wall of the first docking ring are provided in the first docking chamber and the at least one guide docking protrusion and the another guide docking protrusion protruded and extended on an inner wall of the second docking ring are provided in the second docking chamber.

7. The Type-C receptacle load-bearing docking protection device, as recited in claim 4, wherein at least one receptacle mounting base of the first receptacle mounting base and the second receptable mounting base is installed to at least one load-bearing docking housing of the first load-bearing docking housing and the second load-bearing docking housing correspondingly in a limiting rotatable manner and links with a rotating linkage plate, which is linked and driven by a rotation of the at least one receptacle mounting base with respect to the at least one load-bearing docking housing, wherein the rotating linkage plate is stretchedly linked with a resilient element arranged in the at least one load-bearing docking housing, so as to retain the at least one receptacle mounting base at a stretched and restricted initial state while the at least one receptacle mounting base is limitable and rotatably installed to the at least one load-bearing docking housing, such that an installation of the at least one receptacle mounting base to the at least one load-bearing docking housing in a repositionable and rotatable manner is implemented.

8. The Type-C receptacle load-bearing docking protection device, as recited in claim 7, wherein the at least one receptable mounting base further includes a bottom plate, a linkage member and at least one engaging member, wherein the rotating linkage plate has a linkage slot and at least one engaging slot, wherein the rotating linkage plate is mounted in the at least one receptacle mounting base in such a manner that the linkage member is inserted in the linkage slot and engaged with the rotating linkage plate in a direction of inserting into the linkage groove, and the engaging member is inserted into the linkage groove and engaged with the rotating linkage plate in a pullout direction from the engaging groove.

9. The Type-C receptacle load-bearing docking protection device, as recited in claim 8, wherein the bottom plate has a rotation limiting member, wherein the rotation limiting member is protruded from an edge of the bottom plate, wherein the at least one load-bearing docking housing has an installation channel, a rotation limiting portion in form of recess is defined at a channel opening communicating the installation channel, wherein while the at least one receptacle mounting base is installed to the at least one load-bearing docking housing, the rotation limiting member of the bottom plate is positioned at the rotation limiting portion so as to limit a rotation direction of the at least one receptacle mounting base within a rotating stroke by the rotation limiting portion.

10-11. (canceled)

12. The Type-C receptacle load-bearing docking protection device, as recited in claim 1, wherein an opening of the first Type-C receptacle is oriented in a height direction of the first receptacle mounting base, the first receptacle mounting base having a plug-in limiting surface raised in the height direction thereof and at least one movement limiting groove positioned at a side position of the first Type-C receptacle and extended in a plugging direction of the first Type-C receptacle, wherein an opening of the second Type-C receptacle is oriented in a height direction of the second receptable mounting base, the second receptable mounting base having at least one movement limiting member positioned at a side position of the second Type-C receptacle and extended in the plugging direction in the height direction thereof, wherein the at least one movement limiting member is sized and shaped structurally matching with the at least one movement limiting groove, wherein when the first Type-C receptacle is aligned with the second Type-C receptacle along the plugging direction of the first Type-C receptacle and the second Type-C receptacle, the opening of the at least one movement limiting groove, located on the plug-in limiting surface is maintained being aligned with the al least one movement limiting member.

13. (canceled).

14. The Type-C receptacle load-bearing docking protection device, as recited in claim 12, wherein the plug-in limiting surface has a height higher than an opening of the first Type-C receptacle and the at least one movement limiting member is higher than an opening of the second Type-C receptacle.

15. The Type-C receptacle load-bearing docking protection device, as recited in claim 14, wherein the plug-in limiting surface has a height higher than an opening of the first Type-C receptacle wherein a shape of an opening of each of the first Type-C receptacle and second Type-C receptacle satisfies a vertical symmetry line and a horizontal symmetry line that are perpendicular to each other, the at least one movement limiting member and another movement limiting member, with respect to the at least one movement limiting groove and another movement limiting groove respectively, being arranged symmetrically with the vertical symmetry line and the horizontal symmetry line on two sides of the Type-C receptacle respectively.

16. A load-bearing docking type motion sensor with Type-C receptacle, including:
a Type-C receptacle, which is configured as one of a Type-C male receptacle and a Type-C female receptacle;
a receptacle mounting base, wherein the Type-C receptacle is installed to the receptacle mounting base; and
a load-bearing docking housing, wherein the load-bearing docking housing is configured to be docked with a relative apparatus so as to be able to bear loading in an unplugging direction of the Type-C receptacle, wherein the receptacle mounting base is installed to the load-bearing docking housing in a repositionable and moveable manner, such that a docking action between the receptacle mounting base and the relative apparatus is able to be implemented while the Type-C receptacle is in a plugged state, and after a docking condition between the load-bearing docking housing and the relative apparatus is released by a release action between the load-bearing docking housing and the relative apparatus, a displacement occurred between the receptacle mounting base and the load-bearing docking housing during a movable docking action of the load-bearing docking housing and the relative apparatus is able to be restored and repositioned and be retained in a repositioned condition.

17. The load-bearing docking type motion sensor with Type-C receptacle, as recited in claim 16, wherein the receptacle mounting base is arranged on the load-bearing docking housing in a repositionable and rotatable manner.

18. The load-bearing docking type motion sensor with Type-C receptacle, as recited in claim 17, wherein the receptacle mounting base is installed to the load-bearing docking housing in a limiting rotatable manner and links with a rotating linkage plate, which is linked and driven by the rotation of the receptacle mounting base with respect to the load-bearing docking housing, wherein the rotating linkage plate is stretchedly linked with a resilient element arranged in the load-bearing docking housing, so as to retain the receptacle mounting base at a stretched and restricted initial state while the receptacle mounting base is limitable and rotatably installed to the load-bearing docking housing, such that the installation of the receptacle mounting base to the load-bearing docking housing in a repositionable and rotatable manner is implemented.

19. The load-bearing docking type motion sensor with Type-C receptacle, as recited in claim 18, wherein the receptable mounting base further includes a bottom plate, a linkage member and at least one engaging member, wherein the rotating linkage plate has a linkage slot and at least one engaging slot, wherein the rotating linkage plate is mounted in the receptacle mounting base in such a manner that the linkage member is inserted in the linkage slot and engaged with the rotating linkage plate in a direction of inserting into the linkage groove, and the engaging member is inserted into the linkage groove and engaged with the rotating linkage plate in a pullout direction from the engaging groove.

20. The load-bearing docking type motion sensor with Type-C receptacle, as recited in claim 19, wherein the bottom plate has a rotation limiting member, wherein the rotation limiting member is protruded from an edge of the bottom plate, wherein the load-bearing docking housing has an installation channel, a rotation limiting portion in form of recess is defined at a channel opening communicating the installation channel, wherein while the receptacle mounting base is installed to the load-bearing docking housing, the rotation limiting member of the bottom plate is positioned at the rotation limiting portion so as to limit a rotation direction of the receptacle mounting base within a rotating stroke by the rotation limiting portion.

21. The load-bearing docking type motion sensor with Type-C receptacle, as recited in claim 17, wherein the load-bearing docking housing includes a docking ring which defines a docking chamber, wherein the Type-C receptacle is fixedly installed in the receptable mounting base while surrounding by the docking ring, wherein the load-bearing docking type motion sensor with Type-C receptacle further has an input unit installation position, so as to provide an installation position for the corresponding input unit, wherein the input unit installation position is arranged at one of the receptacle mounting base and the load-bearing docking housing within the docking chamber.

22-23. (canceled)

24. The load-bearing docking type motion sensor with Type-C receptacle, as recited in claim 16, wherein the Type-C receptacle is affixed to the receptacle mounting base by being embedded in the receptacle mounting base, wherein an opening of the Type-C receptacle is oriented in a height direction of the receptacle mounting base, the first receptacle mounting base having a plug-in limiting surface raised in the height direction thereof and two movement limiting grooves positioned at two side positions of the Type-C receptacle respectively and extended in a plugging direction of the Type-C receptacle, wherein a height of the plug-in limiting surface is higher than the opening of the Type-C receptacle, wherein the two movement limiting grooves are arranged symmetrically at two sides of the Type-C receptacle respectively.

25. The load-bearing docking type motion sensor with Type-C receptacle, as recited in claim 16, wherein an opening of the second Type-C receptacle is oriented in a height direction of the second receptable mounting base, the receptable mounting base having two movement limiting members positioned at sides of the Type-C receptacle and extended in the height direction thereof respectively, wherein the two movement limiting members are higher than the opening of the Type-C receptacle, wherein the two movement limiting members are symmetrically arranged at two sides of the Type-C receptacle.
